(19) United States
(12) Patent Application Publication
(10) Pub. No.: US 2026/0267635 A1
(43) Pub. Date: Sep. 10, 2026

(54) SYSTEM AND METHOD FOR AUTOMATICALLY DETECTING AND CORRECTING CODE SMELLS USING A LANGUAGE-INDEPENDENT DOMAIN-SPECIFIC LANGUAGE

(71) Applicant: King Fahd University of Petroleum and Minerals, Dhahran (SA)

(72) Inventors: Maha Masoud ALHARBI, Makkah (SA); Mohammad Rabah ALSHAYEB, Dhahran (SA)

(73) Assignee: King Fahd University of Petroleum and Minerals, Dhahran (SA)

(21) Appl. No.: 19/071,832

(22) Filed: Mar. 6, 2025

(51) Int. Cl. G06F 8/70; G06F 8/30; G06F 11/3604

(52) U.S. Cl. CPC G06F 8/70; G06F 8/315; G06F 11/3604

(57) ABSTRACT

A method and system for automatically detecting code smells in a source code in any of object-oriented programming languages and performing code correction includes processing circuitry configured with a DSL component, a code smells detection component, a code smells correction component and a reporting component. The DSL component maintains a representation of linguistic structures of a DSL using a formal grammar. The DSL is a language-independent formal language to solve a class of problems in a domain of knowledge. The code smells detection component applies smell detection rules for detecting a code smell type to the source code to detect potential code smells and maintains an extensible set of smell specifications templates. The code smells correction component applies the DSL to specify corrective actions for each detected code smell and generates corrected source code based on the corrective actions. The reporting component outputs the corrected source code.

### BACKGROUND

### Technical Field

The present disclosure is directed to software engineering and, more particularly, to systems and methods for automatically detecting and correcting code smells using a language independent domain-specific language.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Code smell detection and correction are areas of software engineering that help to ensure software maintainability and quality. Code smells refer to design or implementation issues that may not cause immediate defects but indicate deeper problems in a code. Addressing the code smells typically involves refactoring, which improves an internal structure of the code without changing its external behavior. While manual inspection for identifying the code smells and refactoring opportunities is possible, it is time-consuming, error-prone, and infeasible for large-scale systems. As such automation in this domain has gained significant attention, leading to the development of numerous automated approaches for detecting and correcting the code smells.

Refactoring involves improving code structure without changing its functionality, and the preconditions-oriented approaches are crucial in ensuring that the refactorings preserve the program's behavior. Refactoring processes are categorized based on their level of automation, such as manual, semi-automated, and fully automated. Fully automated refactoring processes hold significant potential, especially for large and complex systems. The fully automated refactoring approaches are classified into six approaches: quality-metric-oriented, preconditions-oriented, clustering-oriented, graph-oriented, code-slicing, and dynamic analysis-oriented approaches. The quality-metric-oriented approaches leverage software metrics like cohesion, coupling, and complexity to identify refactoring opportunities. However, these approaches often rely on manually defined rules and thresholds and lack universal applicability. Also, these approaches have computational overhead due to extensive search spaces and subjective metrics-based evaluations, reducing scalability and generalization across different software systems.

The clustering-oriented approaches aim to group similar code elements based on predefined features, such as structural or behavioral characteristics, to automate identification of potential refactoring candidates. However, the effectiveness of clustering depends on the chosen similarity measures and features, which may not always capture the full context of the code. Moreover, these methods are computationally expensive, especially for large software systems, and require significant tuning of parameters like a number of clusters or distance measures, which limits their effectiveness across different code structures.

The graph-oriented approaches involve automated modeling of software systems as graphs and analyzing dependencies and relationships to find the refactoring opportunities. However, these approaches often face challenges in scalability, especially for the large systems with complex graph structures, leading to increased computational cost and complexity. Additionally, the accuracy of graph construction depends on the completeness and precision of code analysis.

The code slicing-oriented approaches focus on automatic extraction of relevant portions of the code (slices) that influence a particular computation or behavior and analyzing these slices to find the refactoring opportunities. However, these approaches depend on precise dependency analysis, which can be time-consuming and difficult for complex systems. Additionally, the granularity of the slices may not always align with the intended refactoring goals, leading to suboptimal results.

The dynamic analysis-oriented approaches focus on the runtime behavior of software, collecting execution data (such as method calls, variable values, and control flow) to detect the potential refactoring opportunities. However, the dynamic analysis-oriented approaches are limited by their inability to analyze the code that is not executed during profiling, which could lead to incomplete recommendations. Furthermore, the dynamic analysis-oriented approaches are resource-intensive, requiring extensive runtime instrumentation and profiling, making them impractical for the large-scale systems or production environments.

Accordingly, it is one object of the present disclosure to provide a system and method for overcoming the limitations of conventional code smell detection and correction approaches by offering a more scalable, flexible, and accurate solution and ensuring better applicability across diverse software environments. It is a further object to provide a fully automated framework that integrates both the detection and correction stage with multiple languages support based on a domain specific language.

### SUMMARY

In an exemplary embodiment, a computer workstation system having memory and processing circuitry and equipped with a software tool for automatically detecting code smells in a source code in any of a plurality of object-oriented programming languages and performing language-specific code correction is described. The system includes a user input device configured to select and retrieve a source code file with the source code from the memory. The memory storing a Domain Specific Language (DSL) component for maintaining a representation of linguistic structures of a DSL using a formal grammar. The DSL is a language-independent formal language that solves a class of problems in a domain of knowledge. The processing circuitry is configured with a code smells detection component to apply smell detection rules to the source code in the source code file to detect potential code smells. Each smell detection rule is for detecting a code smell type. The code smells detection component maintains an extensible set of smell specifications templates. The processing circuitry is further configured with a code smells correction component that applies the DSL to specify specific corrective actions for each detected code smell and generates corrected source code based on the corrective actions. The processing circuitry is further configured with a reporting component that outputs a file with a correction report the corrected source code to the memory.

In another exemplary embodiment, a non-transitory computer-readable storage medium including computer executable instructions, wherein the instructions, when executed by a computer, cause the computer to perform a method for automatically detecting code smells in a source code in any of a plurality of object-oriented programming languages and performing language-specific code correction is described. The method includes selecting and retrieving a source code file having the source code, maintaining, in memory, representations of linguistic structures of a Domain Specific Language (DSL) using a formal grammar. The DSL is a language-independent formal language to solve a class of problems in a domain of knowledge. The method further includes applying, by the processing circuitry, smell detection rules to the source code in the source code files to detect potential code smells. Each smell detection rule is for detecting a code smell type. The processing circuitry maintains an extensible set of smell specifications templates. The method further includes applying the DSL to specify specific corrective actions for each detected code smell and generating, by the processing circuitry, corrected source code based on the corrective actions. The method further includes outputting a file with a correction report for the corrected source code to the memory.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a block diagram of a computer workstation system for automatically detecting code smells in a source code in any of a plurality of object-oriented programming languages and performing suitable code correction, according to certain embodiments.

FIG. 2A illustrates a schematic block diagram representing stages of a code smells analysis process, according to certain embodiments.

FIG. 2B illustrates a high-level system architecture representing components of a processing circuitry, according to certain embodiments.

FIG. 2C illustrates an exemplary system workflow architecture, according to certain embodiments.

FIG. 2D illustrates an exemplary numerical matrix representing a solution generated by a Cuckoo Search (CS) algorithm, according to certain embodiments.

FIG. 2E illustrates a training process for a code correction model, according to certain embodiments.

FIG. 3 illustrates a flowchart of a method for automatically detecting the code smells in the source code in any of the object-oriented programming languages and performing suitable code correction, according to certain embodiments.

FIG. 4 is an illustration of a non-limiting example of details of computing hardware used in a computing system, according to certain embodiments.

FIG. 5 is an exemplary schematic diagram of a data processing system used within the computing system, according to certain embodiments.

FIG. 6 is an exemplary schematic diagram of a processor used with the computing system, according to certain embodiments.

FIG. 7 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Aspects of this disclosure are directed to a system and a method for automatically detecting and correcting code smells in software systems to maintain high software quality and reduce maintenance efforts. Conventional approaches to code smells detection and refactoring are often language-specific, primarily targeting Java codebases, and fail to provide scalable, reusable, and extensible solutions across different programming languages.

The present disclosure relates to a system and a method that employs a Domain-Specific Language (DSL) specified with a formal grammar to enable language-independent detection and refactoring of the code smells. The DSL utilizes generic and formalized representations of the code smells and refactoring techniques, allowing for consistent and scalable solutions across multiple diverse programming languages. By automating the code smells detection and correction phases, the system ensures improved code quality and reduced developer dependency. Moreover, the extensibility of the system allows expansion for new code smells, and corresponding refactoring techniques to address evolving software development needs effectively.

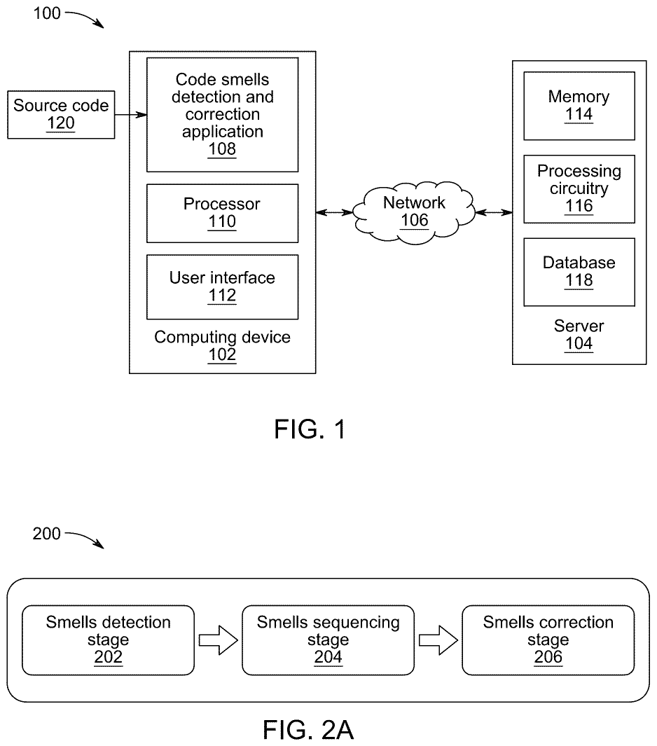

FIG. 1 illustrates a block diagram of a computer workstation system 100 (hereinafter referred to as the system 100) for automatically detecting code smells (hereinafter collectively referred to as the code smells and individually referred to as the code smell) in a source code 120 in any of a several object-oriented programming languages (hereinafter referred to as the object-oriented programming languages) and performing suitable code correction, according to certain embodiments. As used herein, the term “code smells” refers to indicators of potential problems in the source code 120 that may necessitate inspection and correction. The code smells may be, but not limited to, God class, long method, duplicated code, feature envy, data class, and so forth. Embodiments of the present disclosure are intended to include or otherwise cover any code smells, including known, related art and/or later developed code smells. Also, the object-oriented programming language may be, but not limited to, C#, Java, C, C++, Objective-C, JavaScript, Smalltalk, Python, Perl, Ruby, Swift, and the like. Embodiments of the present disclosure are intended to include or otherwise cover any object-oriented programming language, including known, related art and/or later developed technologies.

The system 100 includes a computing device 102 and a server 104. The computing device 102 and the server 104 are connected through a network 106. According to an embodiment, the network 106 may be a computer network such as, but not limited to, the Internet, a local area network (LAN), a wide area network (WAN), a metropolitan area network (MAN), and so forth. Embodiments of the present disclosure are intended to include or otherwise cover any type of the computer network, including known, related art, and/or later developed technologies. In some embodiments, the network 106 may be a wireless network, such as, but not limited to, a cellular network and may employ various technologies, including an enhanced data rates for global evolution (EDGE), a general packet radio service (GPRS), and so forth. Embodiments of the present disclosure are intended to include or otherwise cover any type of the wireless network, including known, related art, and/or later developed technologies.

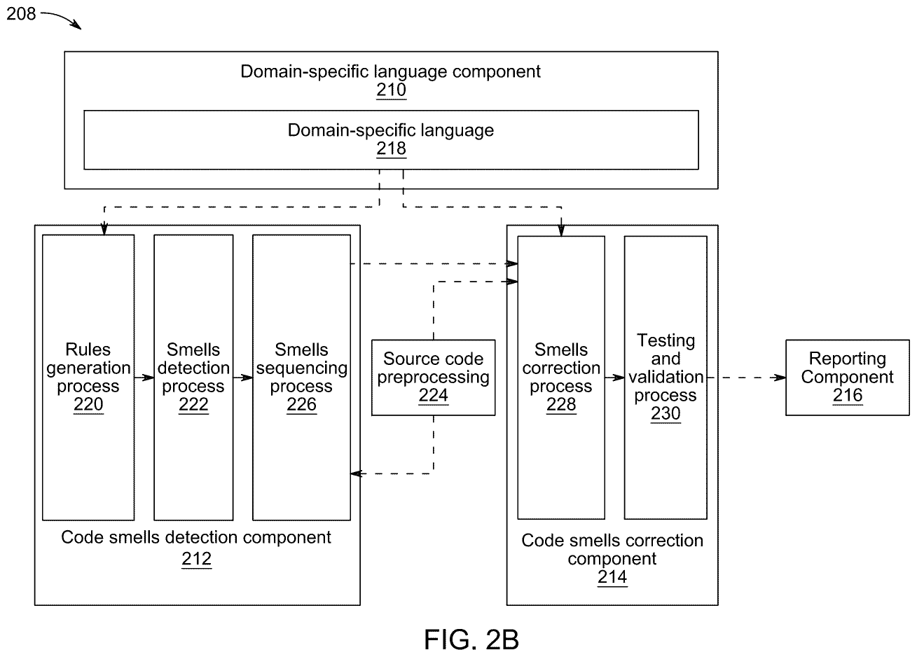

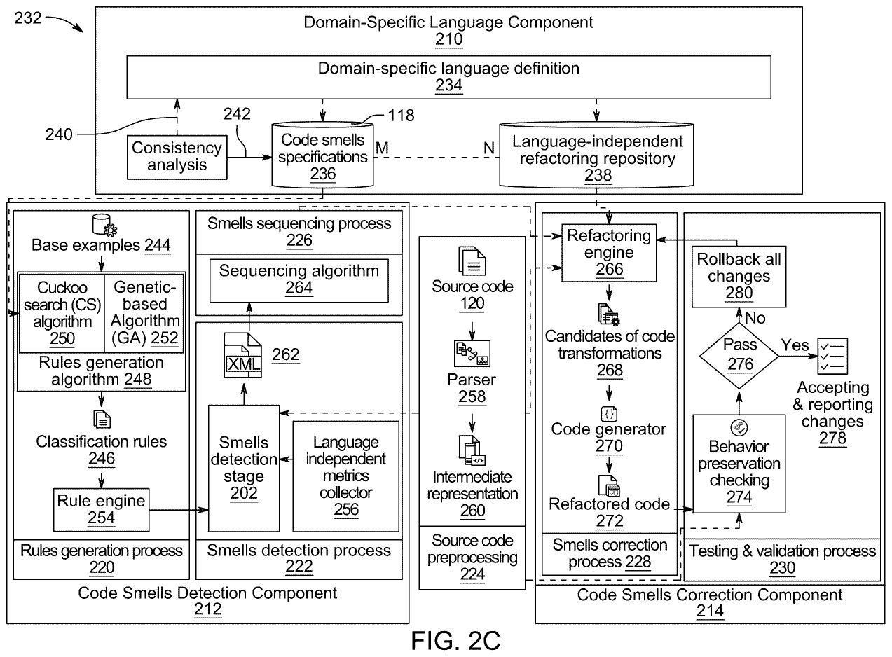

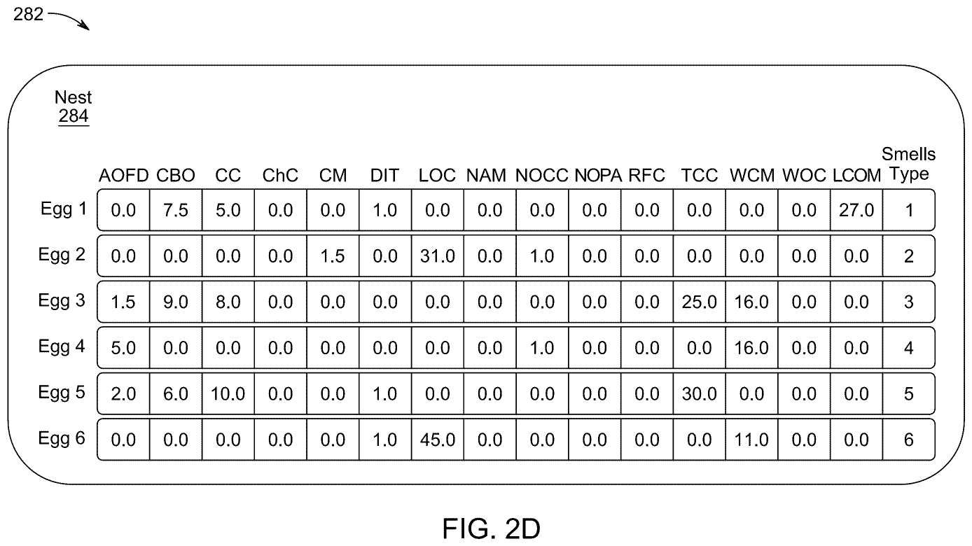

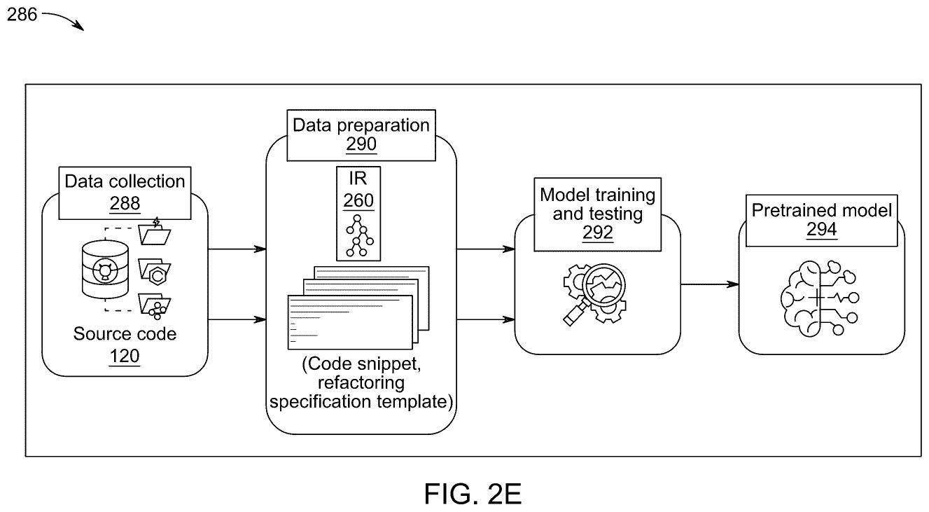

The computing device 102 may be used by a user to configure a code smells detection and refactoring process by defining parameters, rules, thresholds, and the like to identify the code smells. In an embodiment, the computing device 102 may be used by the user to provide the source code 120 to be analyzed. As used herein, the term “refactoring” serves as a solution to address a presence of the code smells in the source code 120. As used herein, the “source code” 120 refers to a collection of human-readable instructions written in the object-oriented programming languages that defines the behavior and functionality of a computer program. In another embodiment, the computing device 102 may be used by the user to employ a Domain Specific Language (DSL) 218 (as shown in FIG. 2B) by adding new code smells and refactoring strategies. As used herein, the term “DSL 218” refers to a specification language designed to address problems within a specific domain. For example, in the domain of code smells detection, the DSL 218 may allow the users to specify rules for identifying the code smells. For example, a rule may be IF Cyclomatic Complexity (CC)>10 AND Lines of Code (LOC)>50, THEN Long Method. In an embodiment, the computing device 102 may also configured to display the outcomes of code smells detection, indicating code areas that require refactoring (i.e., correction). In an embodiment, the computing device 102 may also be used by the user to trigger an automated detection and refactoring process. In an embodiment, the computing device 102 may also be used by the user to review, accept or modify suggested refactoring based on requirements. The requirements refer to specific conditions, constraints or objectives that determine whether the suggested refactoring suits a specific context. The requirements may be, but are not limited to, code functionality requirements (i.e., a corrected source code must preserve original functionality and expected behavior), code quality requirements (i.e., the corrected source code must improve readability and maintainability of the source code 120), and so forth.

The computing device 102 may be, but is not limited to, a mobile device, a smart phone, a tablet, a portable computer, a laptop computer, a desktop computer, a smart device, and so forth. Embodiments are intended to include or otherwise cover any type of the computing device 102, including known, related art, and/or later developed technologies. Further, the computing device 102, as may be readily appreciated by a person skilled in the art, is merely intended to illustrate and not to limit what may encompass the computing device 102, such as, but not limited to, an instant messaging sending device, a short message service (SMS) transmitting device, and/or other messaging devices that may include, but not limited to, a text, graphics, symbols and/or other identifiable communications. In an embodiment, the computing device 102 may be a multipurpose device, such that an operation in accordance with the system 100 is merely one of many (e.g., two or more) features that may be provided by the computing device 102.

According to an embodiment, the computing device 102 may include software applications such as, but not limited to, a navigation application, a camera application, a media player application, a social networking application, and so forth.

The computing device 102 may comprise a processor 110 and a user interface 112. The processor 110 may be configured to receive and/or transmit data (i.e. the source code 120) associated with the system 100 over the network 106. Further, the processor 110 may be configured to process the data associated with the system 100, in an embodiment of the present invention. The processor 110 may be, but not limited to, a programmable logic control unit (PLC), a microcontroller, a microprocessor, a computing device, a development board, and so forth. Embodiments of the present disclosure are intended to include or otherwise cover any type of the processor 110, including known, related art, and/or later developed technologies.

The user interface 112 may be configured to enable the user to interact with a code smells detection and correction application 108 installed within the computing device 102. The user interface 112 may also be configured to display the corrected source code. The user interface 112 may be, but is not limited to, a digital display, a touch screen display, a graphical user interface, and so forth. Embodiments of the present disclosure are intended to include or otherwise cover any type of the user interface 112, including known, related art, and/or later developed technologies.

In a preferred embodiment, the code smells detection and correction application 108 may be connected to the server 104, to store and retrieve corrective actions and processed results. The corrective actions may be, but not limited to, extract class (where related methods and attributes are moved into a new and more focused class), extract method (breaking down the lengthy method into smaller methods), consolidate duplicate code (i.e., unify the redundant code segments into a single method or class), move method (i.e., relocating the method to the class with which the method most frequently interacts with), and so forth. The code smells detection and correction application 108 may be a computer-executable program installed on the computing device 102 for executing functions associated with the system 100 on the computing device 102. In an embodiment, the functions associated with the system 100 may be, analysing, detecting and correcting the code smells in the source code 120.

In an embodiment, the user may directly upload the source code 120 to the code smells detection and correction application 108 using the user interface 112. In another embodiment, the code smells detection and correction application 108 may be integrated with an Integrated Development Environment (IDE) to capture the source code 120 automatically as the user types/writes or modifies the source code 120. This integration enables the code smells detection and correction application 108 to collect the latest version of the source code 120 in real-time without requiring manual uploads from the user. In yet another embodiment, the code smells detection and correction application 108 may be integrated with a version control system (VCS), to continuously monitor commits or code pushes made by the developers. For example, whenever the source code 120 is pushed to the VCS, the code smells detection and correction application 108 may be configured to pull the source code 120 automatically. In another embodiment, the code smells detection and correction application 108 may be integrated with a Continuous Integration (CI) pipeline. The CI pipeline is an automated process where whenever the user pushes the source code 120 changes to a repository and triggers the CI pipeline, the code smells detection and correction application 108 may capture the source code 120 from a build process. In an embodiment, the code smells detection and correction application 108 may be configured to capture the source code 120 while writing the source code 120. In another embodiment, the code smells detection and correction application 108 may be configured to capture the source code 120 on a scheduled basis at predefined regular intervals. In yet another embodiment, the code smells detection and correction application 108 may be configured to capture the source code 120 upon receiving a specific trigger (command), such as after a new commit, merge, build process, and the like.

In an embodiment, the code smells detection and correction application 108 may be configured to process the captured source code 120 for detecting and correcting the code smells. In such embodiment, the code smells detection and correction application 108 may be configured to process the source code 120 locally on the computing device 102 when the computing device 102 has sufficient processing power and storage capabilities to handle code analysis and refactoring processes locally. In another embodiment, the code smells detection and correction application 108 may be configured to transmit the captured source code 120 to the server 104 through the network 106 to process the source code 120.

In some examples, the code smells detection and correction application 108 may be a software from an application distribution platform. Examples of the application distribution platforms include the App Store for iOS provided by Apple Inc., Play Store for Android Operating System (OS) provided by Google Inc., and such application distribution platforms.

In an embodiment, the computing device 102 may also include a local storage (not shown) that may be configured to store the captured source code 120. The local storage may also be configured to store computer-executable instructions for detecting and correcting the code smells in the source code 120. The local storage may also be configured to store code smells detection outcomes, the corrective actions, and so forth. The local storage may be, but not limited to, Hard Disk Drive (HDD), cache memory, flat files, external drives, and so forth. Embodiments of the present disclosure are intended to include or otherwise cover any type of the local storage including known, related art, and/or later developed technologies.

In an embodiment, the server 104 may include a memory 114, a processing circuitry 116, and a database 118. The memory 114 may be a non-transitory data storage medium configured to store the computer-executable instructions for controlling operations of the system 100. The memory 114 may be, but is not limited to, a random-access memory (RAM), a read-only memory (ROM), a flash memory, and so forth. Embodiments of the present disclosure are intended to include or otherwise cover any type of the memory 114 including known, related art, and/or later developed technologies.

Further, the processing circuitry 116 may be connected to the memory 114 to execute the computer-executable instructions to perform the operations associated with the system 100. The operations may be parsing the source code 120, detecting and correcting the code smells. The processing circuitry 116 may include the programmable logic control unit (PLC), the microcontroller, the microprocessor, the computing device, the development board, and so forth. Embodiments of the present disclosure are intended to include or otherwise cover any type of the processing circuitry 116, including known, related art, and/or later developed technologies. In an embodiment, components of the processing circuitry 116 and the processor 110 may be explained in detail in conjunction with FIG. 2B and FIG. 2C.

In an embodiment, the database 118 may be configured to store definitions and classifications of different code smells (e.g., long method, duplicated code, large class, etc.), detection rules, refactoring templates, records of detected smells including type, locality, severity and context, Intermediate Representations (IRs) 260 (as shown in FIG. 2C), base examples 244 (as shown in FIG. 2C), code smells specifications 236 (as shown in FIG. 2C), and so forth. According to embodiments of the present disclosure, the database 118 may be, for example, but not limited to, a centralized database, a distributed database, a personal database, an end-user database, a commercial database, a structured query language (SQL) database, a non-SQL database, an operational database, a relational database, a cloud database, an object-oriented database, a graph database, and so forth. Embodiments of the present disclosure are intended to include or otherwise cover any type of the database 118 including known, related art, and/or later developed technologies that may be capable of data storage and retrieval.

FIG. 2A illustrates a schematic block diagram representing various stages of a code smells analysis process 200, according to certain embodiments.

The code smells analysis process 200 includes a smells detection stage 202, a smells sequencing stage 204 and a smells correction stage 206. The smells detection stage 202 is an initial stage in the code smells analysis process 200, where potential code smells are identified from the source code 120. The identified code smells are transmitted to the smells sequencing stage 204 where the identified code smells are sequenced (prioritized). Further the identified and sequenced code smells are transmitted from the smells sequencing stage 204 to the smells correction stage 206. In the smells correction stage 206, the identified and sequenced code smells are corrected. Each stage of the code smells analysis process 200 is explained in detail in conjunction with FIGS. 2B and 2C.

FIG. 2B illustrates a high-level system architecture 208 representing the components of the processing circuitry 116, according to certain embodiments. The processing circuitry 116 is configured with the components such as a Domain-Specific Language (DSL) component 210, a code smells detection component 212, a code smells correction component 214 and a reporting component 216. In an embodiment, the processor 110 may be configured with the components as described above for the processing circuitry 116.

The DSL component 210 is configured to develop a designed DSL 218, which forms the foundation of a solution for automated language-independent refactoring. The DSL syntax provides a consistent format to represent refactoring operations and code elements across various object oriented programming languages. In an embodiment, the designed DSL 218 may be a custom-designed DSL tailored to a specific domain. In such embodiment, the designed DSL 218 may include syntax, semantics and constructs of the DSL 218 to address the unique requirements of a targeted domain. The targeted domain may be, but is not limited to, database management, web development, networking, mathematical computing, and so forth. In a preferred embodiment, the targeted domain may be code quality and analysis. The DSL 218 is designed to enable language-independent functionality, ensuring broad applicability across various object-oriented programming languages.

The DSL component 210 maintains a representation of the linguistic structures of the DSL 218 using a formal grammar. As used herein, the linguistic structure refers to a formal representation of code elements and syntax rules within the object-oriented programming language that defines how components (e.g., classes, methods, objects, attributes, and the like) interact or relate to each other. The linguistic structures of the DSL 218 may include syntax, grammar, and semantics, which govern how language elements such as keywords, variables, expressions, and constructs like classes, attributes and methods are defined, structured and interpreted. The linguistic structures also define interactions between the classes, the attributes and the methods to ensure desired functionality. For instance, the linguistic structure for the code elements such as a class, an attribute and a method in the DSL 218 may be represented by using the following formal grammar rules:

CLASS_DEF ::= “class” CLASS_NAME (ATTRIBUTE_DEF | METHOD_DEF)*,
ATTRIBUTE_DEF ::= “attribute” ATTR_NAME ATTR_TYPE,
METHOD_DEF ::= “method” METHOD_NAME METHOD_BODY,

where CLASS_DEF defines a class using a keyword “class”, followed by a class name (CLASS_NAME) and optional multiple attributes or methods. ATTRIBUTE DEF defines an attribute using the keyword “attribute” followed by an attribute name (ATTR_NAME) and an attribute type (ATTR_TYPE). METHOD_DEF defines a method using the keyword “method”, followed by a method name (METHOD_NAME) and a method body (METHOD_BODY).

In addition to defining the code elements, the DSL 218 includes the grammar rules for specifying refactoring steps, which defines transformations (i.e., corrected source code) to eliminate the identified code smells. For example: EXTRACT_CLASS::=“extract class” SOURCE_CLASS TARGET_CLASS,
where EXTRACT_CLASS defines a refactoring operation where a new class is created from an existing class. This grammar rule defines an extract_class operation, which takes an existing class (SOURCE_CLASS) and creates a new class (TARGET_CLASS) by extracting parts of an original class.

EXTRACT_METHOD ::= “extract_method” SOURCE_METHOD TARGET_CLASS
METHOD_NAME,

where EXTRACT_METHOD defines the refactoring operation that extracts part of a method into a new method. This grammar rule defines extract_method operation, which extracts part of an existing method (SOURCE_METHOD) and places it into a new method

(METHOD_NAME) in the TARGET_CLASS.
MOVE_METHOD ::= “move_method” METHOD_NAME SOURCE_CLASS
TARGET_CLASS,

where MOVE_METHOD defines the refactoring operation where a method is moved from one class to another. This grammar rule defines the move_method operation, which takes a method (METHOD_NAME) from the SOURCE_CLASS and moves it to the TARGET_CLASS.

The above-mentioned formal grammar rules capture the linguistic structure of both the code elements and the refactoring steps, enabling the DSL 218 to standardize and formalize the representation of the programming constructs and operations. This standardization enhances the extensibility and usability of the DSL 218 across multiple diverse object-oriented programming languages. Furthermore, the grammar rules help capture refactoring instructions in a standardized format, ready for translation into the intermediate representation.

The DSL 218 is a language-independent programming language designed to solve a class of problems in a domain of knowledge. For example, the DSL 218 is designed to solve problems in a software development domain such as detecting and correcting the code smells across multiple object-oriented programming languages.

In an embodiment, the DSL 218 may provide a formal, concise and flexible way to express specifications for the code smells and corresponding refactoring operations, facilitating the reuse of the code smells and the refactoring operations across various object-oriented programming languages. For example, to address “God class” code smell, the DSL 218 may define the “God class” code smell using measurable thresholds like lines of code exceeding 500 or number of methods exceeding 20. This specification is abstracted to apply across different object oriented programming languages such as Java, Python, C++, and so forth. For the refactoring operation, the DSL 218 specifies actions like extracting certain attributes and methods for the “God class” into a new class. This language-specific implementation ensures that conventions are followed. For instance, in Java, the DSL 218 may specify creating private attributes into public getter and setter methods for proper encapsulation. In Python, the DSL 218 may specify dynamic typing and naming private variables with an underscore prefix.

The DSL 218 may also support a high-level representation of language-specific features while hiding unnecessary details, making it easier for developers to use. For example, the DSL 218 may provide a simple command for detecting the “long method” code smell instead of requiring the developers to write intricate logic for detecting it in any programming language.

In an embodiment, the DSL 218 design involves defining both concrete syntax (how the language looks) and abstract syntax (structure of the language).

The code smells detection component 212 is configured to perform various steps to identify and manage the code smells within the system 100.

At step 220, the code smells detection component 212 is configured to utilize the DSL 218 to generate a set of smell detection rules. In an embodiment, each smell detection rule detects a code smell type. In an embodiment, the smell detection rules may be written in the syntax of the designed DSL 218, and structural, measurable and lexical code characteristics may be defined to identify specific code smell types. In an exemplary embodiment, the structural characteristics may include information associated with a structure of the code elements such as, the classes, the methods, the parameters, the variables, and relationships between the code elements. The measurable characteristics may include metrics like chidamber and kemerer metrics suite to assess internal attributes (e.g., cyclomatic, complexity, coupling, and cohesion) of the code elements. The lexical code characteristics may be represented by names or keywords that help identify the specific code smells.

The code smell types may be but are not limited to, long methods (i.e., methods that contain too many lines of code, making the code difficult to read, understand and maintain), large classes (i.e., classes in a codebase that has too many fields, methods or responsibilities, making such classes overly complex and hard to maintain. For example, a “customerManager” class that handles customer data, processes order, manages invoices, sends notifications and generates reports all within a same class), duplicate codes (For example, the duplicate code occurs when the same functionality, such as, calculating a discount or processing user input is implemented in multiple parts of the program), and the like. In an embodiment, the code smells detection component 212 may include a configuration file that includes parameter-value pairs, to define a threshold for lines of code, number of fields, number of methods, to name a few. Embodiments of the present disclosure are intended to include or otherwise cover any type of the code smell types including known related art and/or later developed code smell types.

At step 222, the code smells detection component 212 is configured to apply the generated smell detection rules to a preprocessed source code (i.e., Intermediate Representation (IR) 260) to detect the potential code smells. In step 222, the code smells detection component 212 is configured to detect the code smells in accordance with whether the code smell type has structural, lexical or measurable code characteristics.

In an embodiment, the processing circuitry 116 is configured to obtain the preprocessed source code (i.e., IR 260) at step 224 by transforming the source code 120 (i.e., original source code) into the Intermediate Representation (IR) 260, which captures essential information about the structure and behavior of the source code 120 while abstracting language-specific syntax. In an embodiment, the code smells detection component 212 may be configured to process the IR 260 for consistent detection of the code smells. The IR 260 provides a unified structure across the multiple object-oriented programming languages that capture the structure, relationships, and metrics required for analysis.

For example, the IR might capture class and method information as follows:

| | |
|---|---|
| 1. | { |
| 2. | “classes”: [ |
| 3. | { |
| 4. | “name”: “ClassName”, |
| 5. | “methods”: [ |
| 6. | { |
| 7. | “name”: “MethodName”, |
| 8. | “metrics”: { |
| 9. | “loc”: 60, |
| 10. | “cc”: 12, |
| 11. | } |
| 12. | “calls”: [“OtherClass.otherMethod”], |
| 13. | “access_modifier”: “public” |
| 14. | } |
| 15. | ], |
| 16. | “attributes”: [ |
| 17. | {“name”: “attribute1”, “type”: “int”, “access_modifier”: “private”}, |
| 18. | {“name”: “attribute2”, “type”: “String”, “access_modifier”: “protected”} |
| 19. | ], |
| 20. | “metrics”: { |
| 21. | “loc”: 200, |
| 22. | “nom”: 20, |
| 23. | “noa”: 5, |
| 24. | “noc”: 3, |
| 25. | “cc”: 5 |
| 26. | } |
| 27. | } |
| 28. | ] |
| 29. | |
| 30. | “refactoring”: “Method_Extraction”, |
| 31. | “source_class”: “ClassName”, |
| 32. | “target_class”: “ClassName”, |
| 33. | “attributes_to_extract”: [“attribute1”, “attribute2”], |
| 34. | “methods_to_extract”: [“MethodName1”, “MethodName2”], |
| 35. | “body”: [“type”: “expression”,...], |
| 36. | } |

By focusing on attributes, methods, and key metrics instead of language syntax, this IR enables language-independent smell detection and refactoring.

For example, metrics like LOC (Lines of Code), NOM (Number of Methods), and CC (Cyclomatic Complexity) remain consistent across different object-oriented programming languages, which makes it easier to identify smells like God Class or Long Method. Class and method details, attributes like access modifiers, relationships, and method calls are captured to detect code smells, such as Feature Envy or Data Class, regardless of the target language syntax.

Additionally, the IR incorporates refactoring specifications, which include the source and target classes, methods or attributes to extract, and the refactoring action. This provides the framework with sufficient detail to automate refactoring operations such as: Detecting excessive LOC or NOM to refactor a God Class; Evaluating high CC or LOC in methods to apply Method Extraction; and Identifying attributes and methods for extracting a new class in the case of a Data Class smell.

Certain behaviors and features are unique to specific languages and may require additional handling. For example, multiple inheritance is supported in C++ but not in Java. This difference necessitates an adjustment in the framework to handle this language-specific feature when working with C++ projects.

To deal with the multiple inheritance in the present framework, an additional field can be added in the Intermediate Representation (IR) of the source code to indicate that a class inherits from multiple parent classes. During code generation, the framework can either retain multiple inheritance for target languages that support it (e.g., C++) or convert it into interface-based implementations for languages like Java.

The following is an example that demonstrates the IR structure representing multiple inheritance, where class C inherits methods from classes A and B:

| | |
|---|---|
| 1. | { |
| 2. | “class”: “C”, |
| 3. | “inherits”: [“A”, “B”], |
| 4. | “methods”: [ |
| 5. | {“name”: “methodA”, “from”: “A”}, |
| 6. | {“name”: “methodB”, “from”: “B”} |
| 7. | ] |
| 8. | } |

The following is an example that illustrates the generated code in C++ for this scenario, preserving the multiple inheritance structure:

| | |
|---|---|
| 1. | class A { |
| 2. | public: |
| 3. | void methodA( ) { } |
| 4. | }; |
| 5. | |
| 6. | class B { |
| 7. | public: |
| 8. | void methodB( ) { } |
| 9. | }; |
| 10. | |
| 11. | class C : public A, public B { |
| 12. | // C inherits both methodA( ) and methodB( ) |
| 13. | }; |

The following is an example that shows the equivalent Java implementation using interfaces to achieve the same behavior:

| | |
|---|---|
| 1. | interface A { |
| 2. | void methodA( ); |
| 3. | } |
| 4. | |
| 5. | interface B { |
| 6. | void methodB( ); |
| 7. | } |
| 8. | |
| 9. | class C implements A, B { |
| 10. | public void methodA( ) { } |
| 11. | public void methodB( ) { } |
| 12. | } |

At step 226, the code smells detection component 212 is configured to prioritize (sequence) the detected code smells to generate a sequence of the code smells. The code smells detection component 212 may be configured to prioritize the detected code smells based on the potential impact of each detected code smell on the maintainability, readability, performance and quality of the source code 120. The code smells detection component 212 is configured to transmit the detected code smells to the code smells correction component 214.

The code smells correction component 214 is communicatively coupled to the code smells detection component 212 to receive the detected code smells. The code smells correction component 214 is also configured to perform various steps to address the detected code smells and implement corrective actions. The corrective actions may be, but not limited to, extract class (where related methods and attributes are moved into a new and more focused class), extract method (breaking down the lengthy method into smaller methods), consolidate duplicate code (i.e., unify the redundant code segments into a single method or class), move method (i.e., relocating the method to the class with which the method most frequently interacts with), and so forth.

At step 228, the code smells correction component 214 uses the DSL 218 to describe specific corrective actions for each detected code smell. The corrective actions are then implemented through automated scripts for generating the corrected source code. In an embodiment, the automated scripts are generated based on the corrective actions.

At step 230, the code smells correction component 214 executes a series of tests on the corrected source code to verify the functionality of the corrected source code. The functionality of the corrected source code is verified to determine whether the corrected source code is consistent with the corresponding specification after refactoring (i.e., correction). In other words, the code smells correction component 214 ensures that modifications on the source code 120 do not alter the intended behavior of the code. The code smells correction component 214 is configured to transmit the corrected source code to the reporting component 216.

The reporting component 216 is communicatively coupled to the code smells correction component 214 to receive the corrected source code. The reporting component 216 is configured to output the corrected source code. In an embodiment, the reporting component 216 may be configured to output the modified version of the source code 120 that incorporates applied refactoring transformations. In an embodiment, the reporting component 216 may be configured to output the corrected source code by transmitting the corrected source code to the computing device 102 through various output mediums. In an exemplary embodiment, the output mediums may include displaying the corrected source code within the IDE, saving the corrected source code as a file in a specific directory, sending the corrected source code over the network 106 through an Application Programming Interface (API), and so forth.

FIG. 2C illustrates an exemplary system workflow architecture 232, according to certain embodiments. The system workflow architecture 232 illustrates a workflow and an interaction between the components of the processing circuitry 116.

In an embodiment, the DSL component 210 is configured with subcomponents such as a DSL definition 234, the code smells specifications 236, and a language-independent refactoring repository 238. The DSL definition 234 includes a language definition format. The language definition format may refer to a formal specification that defines the syntax, semantics, components, rules, and interaction guidelines of the DSL 218. The language definition format is designed based on the formal grammar for expressing the code smells and corresponding refactoring operations in a structured and formal way. As used herein, the refactoring operations refer to systematic and structured processes of modifying the internal structure of the source code 120 without altering the external behavior or functionality. The refactoring operations may be the corrective actions that include, but are not limited to, extract method, move method, rename variable, rename class, extract class, inline method (i.e., replacing a method call with the method's content when the method is simple or used only once), and the like.

In an embodiment, the code smells specifications 236 may be stored in the database 118. The code smells specifications 236 includes smells specifications templates (hereinafter collectively referred to as the smells specifications templates and individually referred to as the smells specifications template) that define the code smells using the formal grammar of the designed DSL 218. The smells specifications templates are based on textual descriptions of the code smells. For example, the smells specifications template for the code smell “long method” provides a formalized structure to identify and address issues in the source code 120.

In an exemplary embodiment, the “long method” code smell is triggered when the method in the source code 120 exceeds a certain number of lines and handles multiple tasks. This leads to reduced readability and maintainability. The smells specifications template may include symptoms such as, excessive lines of code and multiple logical blocks, along with a recommended refactoring operation such as extracting smaller and focused methods. The smells specifications template helps to standardize the detection and correction of the code smells across various programming language, regardless of the syntax.

The code smells specifications 236 may be designed to be extensible, allowing updates or addition of new code smells based on user requirements or emerging programming practices. This extensibility ensures that the DSL 218 evolves with software development trends, addressing a broader range of code quality issues.

In an embodiment, when the updates are made to the code smells specifications 236 based on a user request, a consistency analysis may be performed at step 240 to facilitate the extensibility of the designed DSL 218. In step 240, the consistency analysis may be performed to check whether all the code smells specifications 236 adhere to a format specified by the designed DSL 218, ensuring no redundancy or incompleteness is introduced in the information captured by the user. In an exemplary embodiment, the consistency analysis may be performed by comparing a current format of the code smells specifications 236 with one or more predefined formats that ensure uniformity. In an exemplary embodiment, the consistency analysis may include detecting duplicate or overlapping code smells that may have been introduced during the updates. In another exemplary embodiment, the consistency analysis may include verifying that all essential components of the specification are included and complete. This includes checking whether any critical attribute (such as refactoring operations) is missing. In yet another exemplary embodiment, the consistency analysis may include using one or more predefined rules or algorithms to check the consistency of the code smells. For example, if the code smell description includes “God class”, the consistency analysis may check that related refactoring operations follow the correct procedure for splitting large classes. The consistency analysis promotes uniformity and standardization across all code smells specifications 236.

In an embodiment, if any updates are made to the code smells specifications 236 based on the consistency analysis, then the corrected or updated code smells specifications 236 may be stored in the database 118 at step 242. The stored code smells specifications 236 ensure that only the valid and consistent versions are stored in the database 118.

In an embodiment, the code smells specifications 236 may be represented as simple rules and composite rules. The simple rules may represent a single measurable property of the source code 120. For example, the “God class” may be defined with the simple rules such as number of methods (NOM)>20, identifying any class with more than 20 methods. The composite rules may be constructed from a logical combination of two or more simple rules using boolean operators like AND and OR. In an exemplary embodiment, the composite rules enable the creation of complex conditions by combining multiple simple rules using the logical operators. For example, the “God class” may be defined with the composite rule that combines a high number of methods (NOM)>20 AND a high cyclomatic complexity (CC>10).

In an embodiment, the code smells specifications 236 may also include a vocabulary that distinguishes between the intra-class smells and the inter-class smells. The intra-class smells include smells within the same class. For example, the “long method” code smell occurs when a method in a class is excessively long, making it hard to read or maintain. The inter-class smells represent smells that are propagating in other classes. For example, “feature envy” code smell occurs when the method in one class excessively uses methods or data from another class. The code smells specifications 236 may also describe the relationship between the smells to facilitate smell identification, smell comparison, and, consequently, quality of detection rules. For example, the “God class” code smell may often coexist with “feature envy” code smell, as the overly “large class” may have methods that access or manipulate data from other classes inappropriately. The distinction between the inter-class smells and the intra-class smells reflects the better spread of the smells over the source code 120, which is also useful in generating better detection rules.

The language-independent refactoring repository 238 is configured to store predefined executable specifications that explain how to apply a particular refactoring operation in response to the detected code smell. The predefined executable specifications may be written using the DSL 218. Each predefined executable specification may be a set of instructions (i.e., program template) that guides the automated application of the refactoring operation on the source code 120. Each predefined executable specification may be composed of two components: smell name and execution steps of refactoring. The first component of the predefined executable specification may identify the specific code smell that has been detected, where the smell name acts as a reference to a particular issue in the source code 120.

The second component contains a sequence of actions required to correct the detected code smell. The actions are written in the DSL 218 format and define how to apply the refactoring operations to eliminate the code smell. For example, if the code smell is “long method”, then the execution steps may involve splitting the method into smaller and more manageable methods.

The code smells detection component 212 is configured to receive a set of templates stored in the database 118 from the DSL component 210. For example, the DSL component 210 provides the template for identifying the “God class” with the predefined rules like NOM>20 and CC>10.

The code smells detection component 212 is configured to maintain an extensible set of templates based on the DSL 218. For example, a new rule for identifying the “large class” based on the size of the class (lines of code (LOC)>500) may be added to the set of templates dynamically and the code smells detection component 212 may maintain the extensible set of templates having the new rule for the “large class”. The code smells detection component 212 is further configured to analyze the description of the code smells by dividing the description of the code smells into the structural code smell characteristics (e.g., detecting improper inheritance hierarchies such as cyclic dependencies), lexical code smell characteristics (i.e., identifying inconsistent naming conventions for methods or variables) and measurable code smell characteristics (i.e., analyzing numerical thresholds such as CC>10). In an embodiment, the code smells detection component 212 is configured to maintain the templates that include the vocabulary distinguishing between the intra-class smells and the inter-class smells. Using such vocabulary reduces the search space in detecting the code smells and increases efficiency.

In an embodiment, the code smells detection component 212 may be configured to execute step 220 for generating a set of classification rules 246 (i.e., smell detection rules). In an embodiment, the smell detection rules may include the set of classification rules 246. In step 220, the code smells detection component 212 is configured to generate the set of classification rules 246 based on the smells specifications templates that distinguish between the inter-class and the intra-class smells and the base examples 244. The use of the smells specifications templates in the code smells detection provides an additional source of information, enabling broader coverage of different smell types. The smells specifications templates reduce execution time by identifying the most suitable analysis technique and determining the extent of the code inspection required to detect the code smell.

In an exemplary embodiment, structural smells require a detection algorithm to perform static analysis of the code structure to generate its corresponding rule. For example, the “God class” example is the structural smell because the “God class” smell is detected by analyzing structural characteristics (i.e., number of methods and cyclomatic complexity) of the code without processing the textual content of the code. However, the detection of the lexical smell, such as code cloning, may require additional support from natural language processing techniques to process the text of the base examples 244 and the source code 120.

The code smells detection component 212 is configured to generate the set of classification rules 246 using a rules generation algorithm 248. In other words, the code smells detection component 212 employs the rules generation algorithm 248 to generate new code smell detection rules (i.e., new classification rules).

In an embodiment, the rules generation algorithm 248 may include a hybrid search algorithm. The hybrid search algorithm may include a combination of Particle Swarm Optimization with Differential Evolution (PSO-DE), Ant Colony Optimization with Tabu Search (ACO-TS), hybrid Firefly algorithm with Simulated Annealing (FA-SA), and so forth. In a preferred embodiment, the hybrid search algorithm may include a combination of Cuckoo Search (CS) algorithm 250 and a Genetic-based Algorithm (GA) 252 as the CS algorithm 250 shows a good performance in generating an initial population characterized by good quality and the GA 252 shows a good performance in terms of searching a domain space.

The CS algorithm 250 receives as input various code smells specifications 236, the base examples 244 and a set of metrics. In an exemplary embodiment, the code smells detection component 212 may be configured to receive the code smells specifications 236 from the DSL component 210. The code smells detection component 212 may be configured to receive the base examples 244 from the database 118. Further, the code smells detection component 212 may be configured to receive the set of metrics from a metric repository (not shown) that maintains a list of measurable code metrics and corresponding thresholds.

The code smells detection component 212 may be configured to translate the DSL-based code smells specifications 236, the base examples 244 and the set of metrics into a machine-readable format that may be used by the CS algorithm 250. The code smells detection component 212 may be configured to feed the translated code smells specifications 236, the base examples 244, and the set of metrics as the input to the CS algorithm 250. In an exemplary embodiment, the code smells specifications 236 may include key characteristics of the different code smells such as “LOC>30” or “CC>10”, which describe issues like “long method” or “God class”. The base examples 244 may be pre-annotated examples of code snippets representing real instances of the code smells, offering concrete references to guide rule generation. The set of metrics may include a predefined list of metrics relevant to identifying code smells. The set of metrics may include, but not limited to, access of foreign data (AOFD), coupling between objects (CBO), cyclomatic complexity (CC), changing classes (ChC), changing methods (CM), depth of inheritance hierarchy (DIT), lines of code (LOC), number of accessor methods (NAM), number of child classes (NOCC), number of methods (NOM), number of public attributes (NOPA), response for class (RFC), tight class cohesion (TCC), weighted changing methods (WCM), weight of a class (WOC), lack of cohesion (LCOM), and so forth.

The CS algorithm 250 uses the inputs to generate an optimal set of rules and the generated optimal set of rules initializes a rule engine 254. In an exemplary embodiment, the CS algorithm 250 begins by exploring a solution space of possible detection rules based on the code smells specifications 236, the base examples 244, and the set of metrics. Through an iterative process, the CS algorithm 250 searches for the optimal set of rules by balancing exploration (discovering new candidate rules) and exploitation (refining the best rules). During exploration, new candidate rules are generated randomly without prior bias. At the same time, during exploitation, the CS algorithm 250 fine-tunes best-performing rules by updating the best-performing rules based on feedback derived from the base examples 244 and the set of metrics.

In an exemplary embodiment, the CS algorithm 250 simulates the behavior of parasitic cuckoo birds, where each “egg” represents a potential rule, and “nests” represent solutions. The cuckoo birds lay their eggs in the nests, and in the CS algorithm 250, this corresponds to generating candidate solutions or rules. When a rule improves, the CS algorithm 250 replaces an old rule, just like an egg replacing another egg in the nest. During a search process, the CS algorithm 250 evaluates a fitness of each rule using objective functions, such as precision, recall, and F1 score, which assess the effectiveness of the rules in detecting the code smells. Further, the CS algorithm 250 iteratively optimizes the candidate rules using search and replacement mechanisms such as Levy flights for exploration, rule replacement, convergence check, and so forth. For example, in the rule replacement mechanism, new rules may be compared to existing rules and a poor-performing rule in a population is replaced with a better-performing rule based on the fitness function. For example, an initial rule like “IF CC>10, THEN Long Method” may be mutated into a more complex rule, such as “IF CC>10 AND LOC>50, THEN Long Method.

The process continues iteratively with the CS algorithm 250 refining the candidate rules until either the fitness score stabilizes (convergence), or a predetermined number of iterations are completed. The final set of candidate rules with highest fitness function scores is selected as the optimal set of rules. Example of the optimal set of rules may include “IF CC>10 AND LOC>50, THEN Long Method” and “IF Coupling>0.8 THEN God Class”.

The rules generation algorithm 248 further includes the GA 252, which mutates the optimal set of rules to enhance their quality before generating a final set of rules. The GA 252 uses a fitness function that evaluates the quality of the generated optimal set of rules using an equation (1):

$$F ( norm ) = \frac{{\sum }_{i = 0}^{c} \frac{{a}_{ic}}{c} + \frac{{a}_{is}}{s}}{2} , \qquad ( 1 )$$

where c is the number of classes in the base example 244, s is the number of considered code smell types, and α_{ic} is the number of classes detected with the smell. In an example, the dis has two values as follows:

$${a}_{is =} \{ \begin{matrix}1 , & if the {i}^{th} class is detected correctly \\ 0 , & otherwise\end{matrix} , \qquad ( 2 )$$

where αᵢₛ values indicate that the result of the fitness function is normalized in a range between 0 and 1.

The rules generation algorithm 248 is configured to store the generated a final set of rules in the rule engine 254 and apply the generated final set of rules to the source code 120 to detect smelly instances.

In an exemplary embodiment, the code smells detection component 212 may be configured to execute step 222 for detecting the code smells. In step 222, the code smells detection component 212 may be configured to transmit the final set of rules to the smells detection stage 202 where the final set of rules (smell detection rules) may be applied to the IR 260. The smells detection stage 202 may also receive the metrics associated with the IR 260 from a language independent metrics collector 256. The language independent metrics collector 256 may be configured to extract the metrics (i.e., CC, LOC, and the like) for individual classes and methods from the IR 260. The language independent metrics collector 256 may be capable to collect the metrics for detecting the code smells regardless of the programming language of the code. In the smells detection stage 202, the final set of rules may be applied to the extracted metrics of the classes and the methods of the IR 260 to find instances of the code smell. Each rule is applied to check if corresponding code smells are present. For example, if the method has CC>10 and more than 50 LOC, it may be identified as the “long method”. If the class has a high coupling value and too many methods, it may be identified as the “God class.” In an exemplary embodiment, the classes and the methods that match the criteria defined by the rules are flagged as having code smells.

In an embodiment, the IR 260 may be obtained by executing step 224 where the source code 120 is fed into a parser 258, which analyzes and transforms the source code 120 into the IR 260. The parser 258 may first perform lexical analysis, which breaks the source code 120 into tokens representing the smallest units like keywords, operators, literals and so forth. Then the parser 258 performs syntactic analysis to check the structure of the source code 120 based on grammar rules, producing an Abstract Syntax Tree (AST) that reflects a hierarchical structure of the program while abstracting away language-specific syntax. Further, the parser 258 performs semantic analysis to ensure that the source code 120 is logically consistent. Further, the parser 258 transforms the AST into the IR 260, which is a language-independent representation.

The IR 260 is a unified abstraction layer that captures essential structural and behavioral information about the source code 120 while abstracting language-specific syntax. The IR 260 allows consistent detection and refactoring of the code smells across various programming languages. The IR 260 includes standard metrics such as LOC, NOM, and CC, enabling the identification of common smells like the “God class” or “long method”, regardless of the underlying language. The IR 260 also abstracts details like attributes, methods, access modifiers, relationships, and method calls, allowing the detection of issues such as the feature envy or the data class. Additionally, the IR 260 incorporates refactoring specifications that define source and target classes, methods or attributes to extract, and the specific refactoring actions to perform. For instance, in the case of the “God class”, the IR 260 may flag excessive LOC and NOM and provide the specifications for splitting the attributes and methods into the new class. Similarly, it may identify high CC in the methods for method extraction or pinpoint attributes and methods for extracting the data class. By focusing on structural abstractions instead of the syntax, the IR 260 ensures language-independent analysis and refactoring, making it adaptable and efficient for use across diverse object-oriented programming languages.

The code smells detection component 212 may be configured to output a report 262 that lists a set of identified classes and methods whose properties and relationships conform to the generated final set of rules from the code smells specifications 236 and the base examples 244. For example, the report 262 may list the classes that have too many methods or too much code (indicating “God class” smell) and methods that are too long (indicating “long method” smell). In an embodiment, each entry in the report 262 includes the class name or the method name that exhibits the identified code smell, a metric value that triggered the identification of the code smell, the code smell type, conformance to the rules (i.e., the rules that are met by the class or method), and so forth. In an embodiment, the report 262 may be generated in a format such as a Portable Document Format (PDF), an Excel (XLSX) format, a HyperText Markup Language (HTML) format, a JavaScript Object Notation (JSON) format, a Comma Separated Values (CSV) format, a plain text format, and so forth. In a preferred embodiment, the report 262 may be generated in an extensible Markup Language (XML) format.

The code smells detection component 212 may be configured to execute step 226 for sequencing the identified code smells. In step 226, the code smells detection component 212 may be configured to transmit the report 262 containing the list of identified code smells to the sequencing algorithm 264. The sequencing algorithm 264 may be configured to sequence the detected smells by using multi-objective covariance matrix adaptation evolution strategy (MO-CMA-ES algorithm). In an embodiment, the sequence of the code smells may be determined based on factors such as the severity of the code smell, complexity in fixing the code smell, frequency of occurrence of the code smell in the source code 120, interdependencies (like some smells may need to be fixed before others), and so forth. The code smells detection component 212 is configured to transmit the sequenced code smells to the code smells correction component 214.

The code smells correction component 214 may be configured to execute step 228 for correcting the identified code smells. In step 228, the code smells correction component 214 includes a refactoring engine 266 and a code generator 270. The refactoring engine 266 may be configured to receive an input of a location and the code elements of the identified code smells from the code smells detection component 212. The refactoring engine 266 may be configured to receive the location and the code elements of the identified code smells with the sequence of applying the refactoring operation from the code smells detection component 212. The refactoring engine 266 is also configured to receive the IR 260 of the source code 120 from the database 118 and a refactoring template from the language-independent refactoring repository 238. The refactoring template may include the specification of the refactoring operation that may be responsible for solving that identified code smell.

The refactoring engine 266 is configured to apply the refactoring operations on smelly code segment (i.e., area of code with the code smell) to generate candidate code transformations 268 based on the sequence of the code smells. In an exemplary embodiment, the refactoring engine 266 may be configured to identify an exact smelly code segment in the IR 260 by mapping the received location and code element information of the identified code smells to the corresponding structure in the IR 260. For example, the location information includes specific file names, line numbers, and code blocks where the code smell exists. The code element information specifies the type of code element affected, such as, the class, the method, the variable, a loop, and so forth. Also, the IR 260 is structured as the AST, control flow graph (CFG), data flow graph (DFG) and so forth. These representations provide a hierarchical navigable format of the source code 120.

The refactoring engine 266 uses the location information to identify a starting node in the IR 260. For example, if the smell is in a method calculate_salary, the refactoring engine 266 may search for a node representing the method calculate_salary in the AST. The refactoring engine 266 may further verify that the identified node matches the type of code element (e.g., class, method, loop, and the like). For example, if the smell is the “long method”, the refactoring engine 266 ensures that the node represents the method, not the variable or the loop. The refactoring engine 266 may further traverse the children or neighboring nodes of the starting node to extract the segments affected by the smell. For example, for the duplicate code smell, the refactoring engine 266 identifies the nodes with identical structures under different branches of the IR 260. Further, the refactoring engine 266 may be configured to tag the smelly segment in the IR 260 for subsequent transformations.

Also, using the smell type (provided in the report 262) received from the code smells detection component 212, the refactoring engine 266 may be configured to retrieve the corresponding refactoring operation from the refactoring template. The refactoring template maps specific code smells to the corresponding refactoring operations. For example, for the “long method,” the refactoring operations may be the extract method or replace temp with query. From the list of refactoring operations for the detected smell type, the refactoring engine 266 may be configured to select an appropriate refactoring operation based on various factors such as, quality improvement potential, code context, user-defined constraints, and so forth. Here, for example, for the “long method”, the extract method is selected as this method has multiple logical segments that make it suitable for decomposition.

The refactoring engine 266 is configured to apply the selected refactoring operations to the smelly code segment in the IR 260 to generate one or more candidate code transformations 268. The candidate code transformations 268 may be suggested modifications to the IR 260, that may be generated based on the selected refactoring operation. The refactoring engine 266 may further be configured to modify the IR 260 based on the candidate code transformations 268. For example, the refactoring engine 266 may update the affected code elements (e.g., classes, methods, variables) in the IR 260 based on the candidate code transformations 268.

The code generator 270 is further configured to generate the refactored code 272 from the candidate code transformations 268 by applying the suggested modifications to the IR 260 and then translating the updated IR to the updated source code (i.e., refactored code 272). As discussed in FIG. 2B, the DSL 218 maintains the representation of the linguistic structures of the DSL 218 using the formal grammar, as the formal grammar supports both the abstract syntax and the concrete syntax. Also, parsers may be automatically generated from the formal grammar, facilitating automated code analysis and refactoring. The formal grammar provides a structured format that supports the automated generation of refactored code 272.

In an exemplary embodiment, a process of generating the refactored code 272 begins with the candidate code transformations 268, which specify the modifications needed to solve the identified code smell. For example, consider the “long method” that needs to be split into smaller methods. The IR 260 of the source code 120 provides the structure and relationship between various code elements like classes, methods and variables. Based on the candidate code transformations 268, the code generator 270 updates the IR 260 by dividing the long method into smaller methods, each focusing on a specific task. The updated IR may indicate that one part of the method calculates regular hours, another part of the method calculates bonuses, and a final part of the method prints salary details. The code generator 270 ensures that these changes maintain the structural integrity of the IR 260. Once the IR 260 is updated, the code generator 270 translates the updated IR into a human-readable source code (i.e., refactored code 272), generating a separate method for each part of the original functionality.

Further, the code smells correction component 214 may be configured to execute step 230 for testing and validating the refactored code 272. The testing and validating of the refactored code 272 may involve step 274 of executing the series of tests (i.e., behavioral test suite) to ensure that the refactored code 272 produces the same output as the source code 120. The behavioral test suite includes a set of test cases representing the expected functionality and edge cases of the source code 120. The set of test cases ensures that the refactored code 272 behaves correctly under different scenarios. The behavioral test suite is first executed on the source code 120 to capture baseline outputs. The baseline outputs serve as a reference for comparison. Further, after applying the candidate code transformations 268 (i.e., refactoring transformations), the test suite is executed on the refactored code 272.

The testing and validating of the refactored code 272 may involve a step 276 of comparing the output of the refactored code 272 with the baseline output of the source code 120 for each test case. The refactored code 272 is considered to have passed the behavioral test if all test cases produce results identical to the results of the source code 120. This confirms that refactored code 272 preserves the original behavior. In an embodiment, if the refactored code 272 passes, then at step 278, changes are accepted, and the updates are reported to the reporting component 216.

In another embodiment, the refactored code 272 fails if any test case produces a result that deviates from the expected output, indicating that the behavior has been altered. In such case, all changes are rolled back at step 280 and transmit a signal to the refactoring engine 266 to review and generate new candidate code transformations.

In an embodiment, a process of generating candidate code transformations 268, applying the refactoring operations and conducting the behavioral tests is repeated in a cyclic manner until a predefined stopping criteria is met. The stopping criteria may include improving code quality attributes such as reducing code complexity or improving cohesion. In an exemplary embodiment, the stopping criteria may be received from the user based on observed outcomes or additional constraints. In another embodiment, the process is repeated until a predefined number of iterations are completed.

FIG. 2D illustrates an exemplary numerical matrix 282 representing a solution generated by the CS algorithm 250, according to certain embodiments. The numerical matrix 282 demonstrates how each item is visually structured to address the complex problem of detecting the code smells.

The CS algorithm 250 represents the solution as the numerical matrix 282 of size n*m. The numerical matrix 282 of size n*m may be utilized to represent nests 284. Here, ‘n’ corresponds to the number of smell detection rules, visualized as “eggs”, and ‘m’ represents the length of each smell detection rule, with each nest 284 as the solution.

Specifically, ‘n’ is set to address six distinct types of code smells such as refused bequest, feature envy, long method, large class, data class and shotgun surgery. Each “egg” within the nest 284 corresponds to the smell detection rule designed to detect one of these smells types, with each smell detection rule being 16 items long. First 15 items contain metrics and their threshold values, and a final item defines the code smells type. For example, Egg 1 might be interpreted as:

IF [CBO > 7.5, AND CC > 5.0, AND DIT > 1.0, AND LCOM > 27.0] THEN [Smells
Type =Refused Bequest Smell].

Here, the CS algorithm 250 randomly generates initial solutions (nests 284) by selecting 3 to 5 metrics from the available 15 metrics. Each metric is assigned with a random threshold value within a predefined range. For example, the initial solution may be: IF [LOC>50 AND CC>4, AND RFC>10] THEN [SMELLS TYPE=Long Method]. Further, the CS algorithm 250 evaluates the accuracy of each rule (eggs) by testing the rule on the base examples 244 from the database 118 as the base examples 244 contain labeled code snippets indicating whether the smell is present. Further, a fitness score is calculated based on metrics like true positives (correctly detected smells) and false positives (incorrectly detected smells). For example, the rule with high accuracy and low false positives gets a higher fitness score.

The CS algorithm 250 may refine the solutions by performing random mutations to explore a broader search space. For example, the mutation is performed by modifying the threshold, such as changing LOC>50 to LOC>45 and adding a new metric DIT>2. Hence, the new rule may be IF [LOC>45 AND CC>4, AND DIT>2] THEN [SMELLS TYPE=Long Method]. The CS algorithm 250 may continue evolving the solutions until the solution converges to a desired fitness score or the predetermined number of iterations is completed.

To further improve diversity, the GA 252 may be applied to mutate logical operators (AND to OR) and comparison operators (e.g., > to <). For example, the original rule was IF [LOC>50, AND CC>4] THEN [SMELLS TYPE=Long Method], and the mutated rule is IF [LOC>50 OR CC<4,] THEN [SMELLS TYPE=Long Method]. Upon completing a search process, the CS 250 outputs the optimal set of rules for detecting the code smells.

FIG. 2E illustrates a training process 286 for a code correction model, according to certain embodiments. The code correction model may be a refactorCODE that is designed to automate the generation of language-specific candidate code transformations 268 during refactoring. The code correction model may act as a bridge between abstract IR and specific syntax and conventions of various object-oriented programming languages. In an embodiment, the code correction model may be a Large Language Model (LLM) designed to facilitate the automatic translation of refactored operations into language-specific transformations.

The training process 286 for the code correction model may include a step 288 of gathering a comprehensive and diverse dataset from open-source projects across multiple object-oriented programming languages like Java, C++, and Python. The dataset is selected to cover various coding scenarios, programming paradigms, and the refactoring operations.

The training process 286 for the code correction model may further include a step 290 of data preparation, where raw data is refined to create unstructured training pairs. Step 290 involves extracting code snippets from the source code 120, generating corresponding IRs 260 that abstract the syntax and the semantics of the source code 120, and creating refactoring specification templates to indicate transformations needed for the refactoring operations. For instance, in cases where a large “God class” is detected, the IR 260 may specify extracting attributes (e.g., attribute 1 and attribute 2) and methods (e.g., method 1 and method 2) into a new class. These extractions are paired with the refactoring specification templates to form training paired examples, enabling the LLM to learn transformation patterns effectively.

The training process 286 for the code correction model involves a step 292 of training the LLM on the training paired examples using supervised learning to enable the LLM to learn how elements of the IR 260 such as, classes, methods, and attributes translated into language-specific constructs. For example, in Java, the code correction model generates the code for the new class with private attributes and public getter/setter methods to ensure proper encapsulation, according to Java's syntax and conventions. Similarly, the code correction model generates C++ transformations based on C++ conventions like std::string for string attributes and access specifiers such as private and public. During this phase, the LLM is iteratively fine-tuned to optimize performance and minimize errors.

After training, step 292 involves evaluating the LLM on unseen data to evaluate its ability to apply learned transformations effectively across different programming languages. For instance, in a scenario involving method extraction from a “God Class,” the code correction model is tested to see if it can generate accurate transformations for Java (using access modifiers like private and public) and for Python (employing conventions like underscores for private methods). This evaluation helps verify that the LLM adapts to diverse languages and coding styles.

The training process 286 for the code correction model involve a step 294 of generating a pre-trained model designed to automate code transformations across various object-oriented programming languages. This pre-trained model encapsulates the knowledge gained during training, where the pre-trained model learned how elements of the IR 260 map to language-specific constructs and refactoring specifications. The pre-trained model acts as a comprehensive repository of transformation patterns, enabling it to generalize the refactoring operations across languages like Java, C++, Python, or even less commonly used languages like Kotlin or Swift. The pre-trained model may be integrated into the refactoring engine 266, allowing seamless automation of the code transformations without requiring manual intervention, thus streamlining the refactoring process for software developers.

The training process 286 may further involve a step of fine-tuning the pre-trained model by utilizing transfer learning. This step involves collecting a smaller dataset that is specific to a target language and training the pre-trained model to include unique characteristics of the target language while leveraging its existing knowledge of shared object-oriented principles. For example, for Swift, the pre-trained model learns the constructs such as protocols, optional and specific access modifiers of the Swift. The updated model is testing on the unseen data from a new language to ensure that the updated model generalizes the transformations effectively and generates syntax-complaint code. The fine-tuned model (code correction model) is integrated into the refactoring engine 266, enabling the refactoring engine 266 to support refactoring for the new language along with previously trained languages.

Furthermore, by fine-tuning the pre-trained model on a smaller dataset of the new language, refactorCODE can adapt to language-specific nuances and conventions to effectively generalize its learned patterns to handle additional languages. For instance, if refactorCODE is initially trained on Java and C++ datasets, transfer learning can enable it to perform equally well on Kotlin or Swift by leveraging shared object-oriented principles while adapting to their unique syntactical features.

In an embodiment, the source code is a text file having a file extension that designates the program language. File extensions can include, but are not limited to “cpp”, “cs”, “py”, “java”, “js”, “rb”. The user interface 112 may include a display for an integrated development environment (IDE). The code smell detection and correction application 108 can be a plug-in for an IDE. The IDE may provide the code smell detection and correction application 108 as a tool displayed in a task bar or as a listing in a menu for tools. The IDE may have one or more source code files open in an editing window. Once the tool for the code smell detection and correction application 108 is selected, the IDE can open a second window along side of, or below, the editing window. The second window can be used to display corrected code that is output by the code smell detection and correction application 108. The second window may also be configured to display a report generated by the code smell detection and correction application 108.

The second window may also include commands for controlling the display and for controlling the code smell detection and correction application 108. For example, a control can be provided for jumping forward or backward to sections of corrected code. A control can be provided for displaying the original source code with indications of code sections having potential code smells, and a control that allows a correction to be made for a particular code section, or skip to a next code section.

The tool for the code smell detection and correction application 108 may further include a configuration interface. The configuration interface may allow for setting types of code smells to be detected and/or types of corrections that may be performed. The configuration interface may be in the form of check boxes for making selections. One selection option can include “all” types of code smells and “all” types of corrections. The tool control may also include an option for automatic code smell detection and correction of the entire source code, or stepping through each code section having a detected code smell at a time.

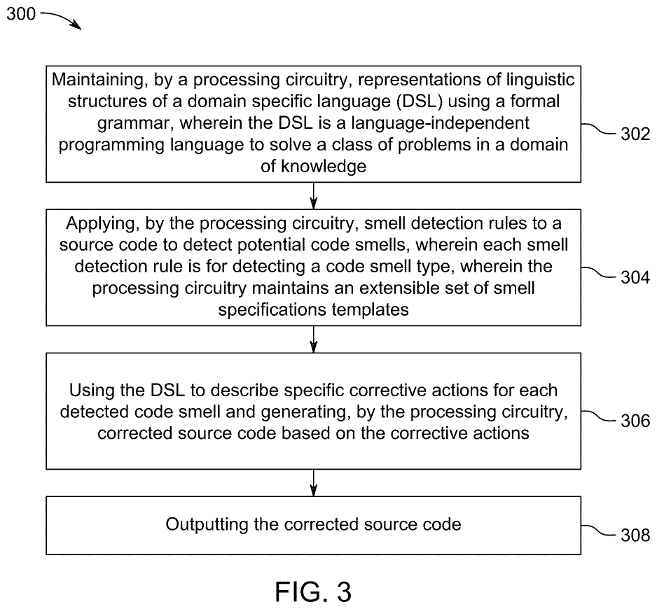

FIG. 3 illustrates a flowchart of a method 300 for automatically detecting the code smells in the source code 120 in any of the object-oriented programming languages and performing suitable code correction, according to certain embodiments. The method 300 includes a series of steps. These steps are only illustrative, and other alternatives may be considered where one or more steps are added, one or more steps are removed, or one or more steps are provided in a different sequence without departing from the scope of the present disclosure.

At step 302, the method 300 includes maintaining, by the processing circuitry 116, the representations of linguistic structures of the DSL 218 using the formal grammar. The DSL 218 is a language-independent formal language that general problems in the domain of knowledge.

At step 304, the method 300 includes applying, by the processing circuitry 116, the smell detection rules to the source code 120 to detect the potential smells. Each smell detection rule is used for detecting a smell type. Each rule is 16 items long, where the first 15 items contain the metrics and their threshold values, and the final item defines a smell type. The processing circuitry 116 maintains the extensible set of smells specifications templates.

Step 304 may further include maintaining, by the processing circuitry 116, the smells specifications templates based on the DSL 218 and dividing the description of the code smells into the structural, lexical, and measurable code smell characteristics. Step 304 further involves detecting, by the processing circuitry 116, code smells in accordance with whether a type of code smell has structural, lexical, or measurable code smell characteristics.

Step 304 further involves maintaining, by the processing circuitry 116, the smells specifications templates to include the vocabulary that distinguishes between the intra-class smells, which includes the smells within a same class, and the inter-class smells, representing the smells that are propagating in other classes. Step 304 also involves automatically generating, by the processing circuitry 116, the set of classification rules 246 based on the smells specifications templates that distinguish between the inter-class and the intra-class smell.

The method 300 also involves a step of performing, by the processing circuitry 116, a rules generation algorithm 248 to generate the new code smell detection rules. This step further includes storing the generated rules in the rule engine 254 and applying the generated rules to the source code 120 to detect the smelly instances. The step further includes outputting the report 262 which lists the set of identified classes and methods whose properties and relationships conform to the generated rules from the code smells specifications 236 and base examples 244. This step also involves receiving, by the CS algorithm 250, the input code smells specifications 236, base examples 244, and the set of metrics and generating the optimal set of rules that initialize the rule engine 254. This step also involves performing the CS algorithm 250 by randomly generating initial solutions, selecting 3 to 5 metrics from an available 15, assigning each a random value within a predefined range to narrow search space and evolving and mutating these solutions through the search process until either convergence is reached or the predetermined number of iterations is completed.

This step further includes mutating, by the GS 252, the generated rules to enhance their quality before generating the final set of rules. This step may further involve performing the GA 252 using the fitness function that evaluates the quality of the generated rules, as defined in equation (1).

At step 306, the method 300 includes using the DSL 218 to describe specific corrective actions for each detected code smell and generating, by the processing circuitry 116, corrected source code based on the corrective actions. Step 306 involves applying the refactoring operations, by the refactoring engine 266, on smelly code segment (i.e., area of code with the detected code smell) to generate the candidate code transformations 268 based on the sequence of the code smells. The candidate code transformations 268 may be suggested modifications to the IR 260, that may be generated based on the selected refactoring operation. Step 306 may further include generating, by the code generator 270, the refactored code 272 (i.e., corrected source code) from the candidate code transformations 268 by applying the suggested modifications to the IR 260 and then translating the updated IR to the corrected source code.

At step 308, the method 300 includes outputting the corrected source code.

The first embodiment is illustrated with respect to FIG. 1-FIG. 2E. The first embodiment discloses the computer workstation system 100 having memory and processing circuitry and equipped with a software tool for automatically detecting code smells in the source code 120 in any of a plurality of object-oriented programming languages and performing language-specific code correction. The system 100 includes a user input device configured to select and retrieve a source code file with the source code from the memory. The memory stores a Domain Specific Language (DSL) component 210 for maintaining a representation of linguistic structures of a DSL 218 using a formal grammar. The DSL 218 is a language-independent formal language to solve a class of problems in a domain of knowledge. The processing circuitry 116 is configured with a code smells detection component 212 to apply smell detection rules to the source code 120 in the source code file to detect potential code smells. Each smell detection rule is for detecting a code smell type. The code smells detection component 212 maintains an extensible set of smells specifications templates. The processing circuitry 116 is further configured with a code smells correction component 214 that applies the DSL 218 to specify specific corrective actions for each detected code smell and generates corrected source code based on the corrective actions. The processing circuitry 116 is further configured with a reporting component 216 that outputs a file with a correction report for the corrected source code to the memory.

In an aspect, the code smells detection component 212 maintains the smells specifications templates based on the DSL 218 and divides a description of the code smells into structural, lexical, and measurable code smell characteristics. The code smells detection component 212 further detects the code smells in accordance with whether the code smell type has structural, lexical, or measurable code smell characteristics.

In an aspect, the code smells detection component 212 maintains the smells specifications templates to include a vocabulary that distinguishes between intra-class smells, which comprise smells within a same class, and inter-class smells, representing smells that are propagating in other classes. The code smells detection component 212 further automatically generates a set of classification rules 246 based on the smells specifications templates that distinguish between the inter-class smells and the intra-class smells.

In an aspect, the code smells detection component 212 performs a rules generation algorithm 248 to generate new code smell detection rules.

In an aspect, the rules generation algorithm 248 includes a Cuckoo Search (CS) algorithm 250 that receives as input code smells specifications 236, base examples 244, and a set of metrics and generates an optimal set of rules that initialize a rule engine 254.

In an aspect, the rules generation algorithm 248 includes a genetic-based algorithm (GA) 252 that modifies the generated optimal set of rules to enhance their quality before generating a final set of rules.

In an aspect, the rules generation algorithm 248 stores the generated rules in the memory and applies the generated rules to the source code 120 to detect smelly instances. The rules generation algorithm 248 further outputs the file with the report 262 that lists a set of identified classes and methods whose properties and relationships conform to the generated rules from code smells specifications 236 and base examples 244.

In an aspect, each smell detection rule is 16 items long; a first 15 items contain metrics and their threshold values, and a final item defines the code smell type.

In an aspect, the Cuckoo Search (CS) algorithm 250 includes randomly generating initial solutions, selecting 3 to 5 metrics from an available 15, and assigning each metric a random value within a predefined range to narrow search space, evolving and mutating these solutions through a search process until either convergence is reached or a predetermined number of iterations is completed.

In an aspect, the genetic-based algorithm (GA) 252 includes applying a fitness function that evaluates the quality of the generated optimal set of rules, as.

$$F ( norm ) = \frac{{\sum }_{i = 0}^{c} \frac{{a}_{ic}}{c} + \frac{{a}_{is}}{s}}{2} ,$$

where c is a number of classes in the base example 244, s is a number of code smell types considered, α_{ic} is the number of classes detected with a smell.

The second embodiment is illustrated with respect to FIG. 3. The second embodiment discloses the non-transitory computer-readable storage medium including computer executable instructions, wherein the instructions, when executed by a computer, cause the computer to perform a method 300 for automatically detecting code smells in a source code 120 in any of a plurality of object-oriented programming languages and performing language-specific code correction. The method 300 includes selecting and retrieving a source code file having the source code. The method 300 includes maintaining, in a memory, representations of linguistic structures of a Domain Specific Language (DSL) 218 using a formal grammar. The DSL 218 is a language-independent formal language to solve a class of problems in a domain of knowledge. The method 300 further includes applying, by the processing circuitry 116, smell detection rules to the source code 120 in the source code file to detect potential code smells. Each smell detection rule is for detecting a code smell type. The processing circuitry 116 maintains an extensible set of smells specifications templates. The method 300 further includes applying the DSL 218 to specify specific corrective actions for each detected code smell and generating, by the processing circuitry 116, corrected source code based on the corrective actions. The method 300 further includes outputting a file with a correction report for the corrected source code to the memory.

In an aspect, the method 300 further includes maintaining, by the processing circuitry 116, the smells specifications templates based on the DSL 218 and dividing a description of the code smells into structural, lexical, and measurable code smell characteristics. The method 300 further includes detecting, by the processing circuitry 116, the code smells in accordance with whether the code smell type has structural, lexical, or measurable code smell characteristics.

In an aspect, the method 300 further includes maintaining, by the processing circuitry 116, the smells specifications templates to include a vocabulary that distinguishes between intra-class smells, which comprise smells within a same class, and inter-class smells, representing smells that are propagating in other classes. The method 300 further includes automatically generating, by the processing circuitry 116, a set of classification rules 246 based on the smells specifications templates that distinguish between the inter-class smells and the intra-class smells.

In an aspect, the method 300 further includes performing, by the processing circuitry 116, a rules generation algorithm 248 to generate new code smell detection rules.

In an aspect, the method 300 further includes receiving, by a Cuckoo Search (CS) algorithm 250, as input code smells specifications 236, base examples 244, and a set of metrics and generating an optimal set of rules that initialize a rule engine 254.

In an aspect, the method 300 further includes mutating, by a genetic-based algorithm (GA) 252, the generated optimal set of rules to enhance their quality before generating a final set of rules.

In an aspect, the method 300 further includes storing the generated rules in the memory and applying the generated rules to the source code 120 to detect smelly instances. The method 300 further includes outputting the file with the report 262 that lists a set of identified classes and methods whose properties and relationships conform to the generated rules from code smells specifications 236 and base examples 244.

In an aspect, each smell detection rule is 16 items long; a first 15 items contain metrics and their threshold values, and a final item defines the code smell type.

In an aspect, the method 300 further includes performing the Cuckoo Search (CS) algorithm 250 by randomly generating initial solutions. The method 300 further includes selecting 3 to 5 metrics from an available 15. The method 300 further includes assigning each metric a random value within a predefined range to narrow search space. The method 300 further includes evolving and mutating these solutions through a search process until either convergence is reached or a predetermined number of iterations is completed.

In an aspect, the method 300 further includes performing the genetic-based algorithm (GA) 252 includes applying a fitness function that evaluates the quality of the generated optimal set of rules.

$$F ( norm ) = \frac{{\sum }_{i = 0}^{c} \frac{{a}_{ic}}{c} + \frac{{a}_{is}}{s}}{2} ,$$

where c is a number of classes in the base example 244, s is a number of code smell types considered, and α_{ic} is the number of classes detected with a smell.

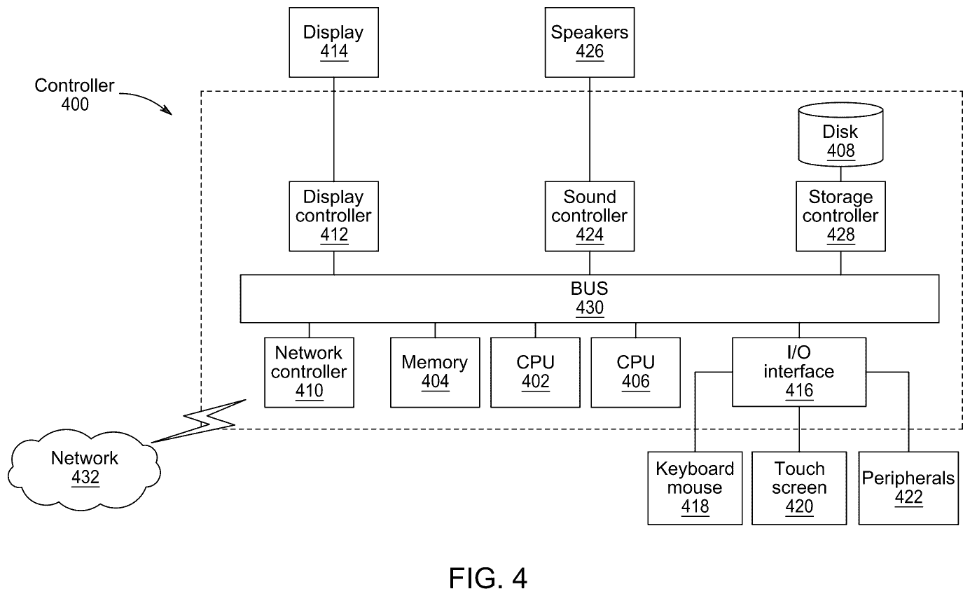

Next, further details of the hardware description of the computing environment according to exemplary embodiments are described with reference to FIG. 4. In FIG. 4, a controller 400 is described as representative of the system 100 of FIG. 1 in which the controller 400 is a processing circuitry 116 which includes a CPU 402 which performs the processes described above/below. The process data and instructions may be stored in a memory 404. These processes and instructions may also be stored on a storage medium disk 408 such as a hard drive (HDD) or a portable storage medium or may be stored remotely.

Further, claims are not limited by the form of the computer-readable media on which the instructions of the inventive process are stored. For example, the instructions may be stored on compact discs (CDs), digital versatile disc (DVDs), in FLASH memory, read access memory (RAM), read only memory (ROM), programmable read only memory (PROM), erasable programmable read only memory (EPROM), electrically erasable programmable read only memory (EEPROM), hard disk or any other information processing device with which the computing device communicates, such as a server or computer.

Further, the claims may be provided as a utility application, background daemon, or component of an operating system, or combination thereof, executing in conjunction with CPU 402, 406 and an operating system such as Microsoft Windows 7, Microsoft Windows 10, UNiplexed Information Computing System (UNIX), Solaris, Lovable Intellect Not Using XP (LINUX), Apple Macintosh (MAC)—Operating System (OS) and other systems known to those skilled in the art.

The hardware elements in order to achieve the computing device may be realized by various circuitry elements, known to those skilled in the art. For example, CPU 402 or CPU 406 may be a Xenon or Core processor from Intel of America or an Opteron processor from advanced micro devices (AMD) of America, or may be other processor types that would be recognized by one of ordinary skill in the art. Alternatively, the CPU 402, 406 may be implemented on a field programmable Gate array (FPGA), application-specific integrated circuit (ASIC), programmable logic device (PLD) or using discrete logic circuits, as one of ordinary skill in the art would recognize. Further, CPU 402, 406 may be implemented as multiple processors cooperatively working in parallel to perform the instructions of the inventive processes described above.

The computing device in FIG. 4 also includes a network controller 410, such as an Intel Ethernet PRO network interface card from Intel Corporation of America, for interfacing with network 432. As can be appreciated, the network 432 can be a public network, such as the Internet, or a private network such as a local area network (LAN) or a wide area network (WAN) network, or any combination thereof and can also include public switched telephone network, (PSTN) or an integrated services digital network (ISDN) sub-network. The network 432 can also be wired, such as an Ethernet network, or can be wireless such as a cellular network including EDGE, 3G and 4G wireless cellular systems. The wireless network can also be Wireless Fidelity (WiFi), Bluetooth, or any other wireless form of communication that is known.

The computing device further includes a display controller 412, such as a NVIDIA GeForce GTX or Quadro graphics adaptor from NVIDIA Corporation of America for interfacing with display 414, such as a Hewlett Packard HPL2445w LCD monitor. A general purpose I/O interface 416 interfaces with a keyboard and/or mouse 418 as well as a touch screen panel 420 on or separate from display 414. General purpose I/O interface also connects to a variety of peripherals 422 including printers and scanners, such as an OfficeJet or DeskJet from Hewlett Packard.

A sound controller 424 is also provided in the computing device such as Sound Blaster X-Fi Titanium from Creative, to interface with speakers/microphone 426 thereby providing sounds and/or music.

The general-purpose storage controller 428 connects the storage medium disk 408 with communication bus 430, which may be an instruction set architecture (ISA), extended industry standard architecture (EISA), video electronics standards association (VESA), peripheral component interconnect (PCI), or similar, for interconnecting all of the components of the computing device. A description of the general features and functionality of the display 414, keyboard and/or mouse 418, as well as the display controller 412, storage controller 428, network controller 410, sound controller 424, and general purpose I/O interface 416 is omitted herein for brevity as these features are known.

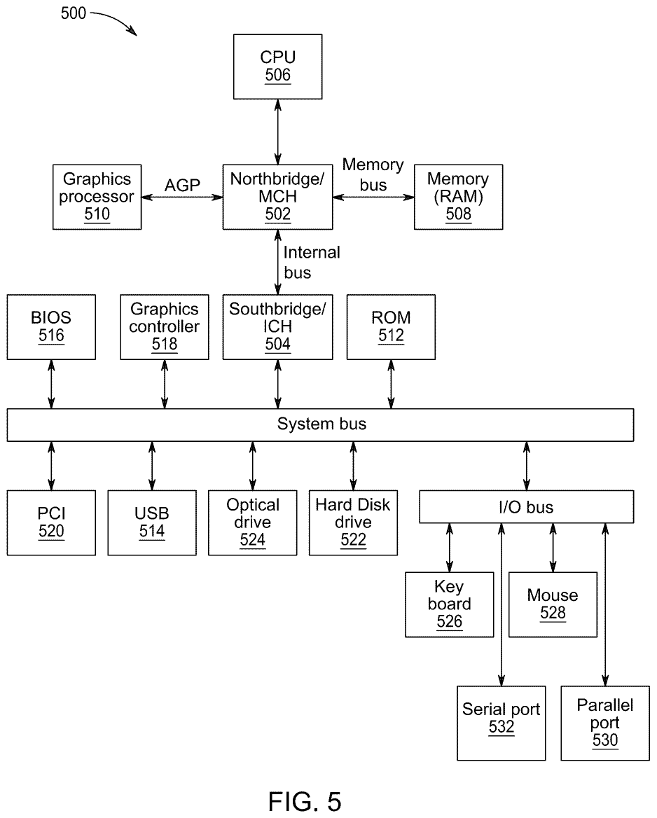

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 5.

FIG. 5 is an exemplary schematic diagram of a data processing system 500 used within the computing system, according to certain embodiments, for performing the functions of the exemplary embodiments. The data processing system 500 is an example of a computer in which code or instructions implementing the processes of the illustrative embodiments may be located.

In FIG. 5, the data processing system 500 employs a hub architecture including a north bridge and memory controller hub (NB/MCH) 502 and a south bridge and input/output (I/O) controller hub (SB/ICH) 504. The central processing unit (CPU) 506 is connected to the NB/MCH 502. The NB/MCH 502 also connects to the memory 508 via a memory bus, and connects to the graphics processor 510 via an accelerated graphics port (AGP). The NB/MCH 502 also connects to the SB/ICH 504 via an internal bus (e.g., a unified media interface or a direct media interface). The CPU 506 may contain one or more processors and even may be implemented using one or more heterogeneous processor systems.

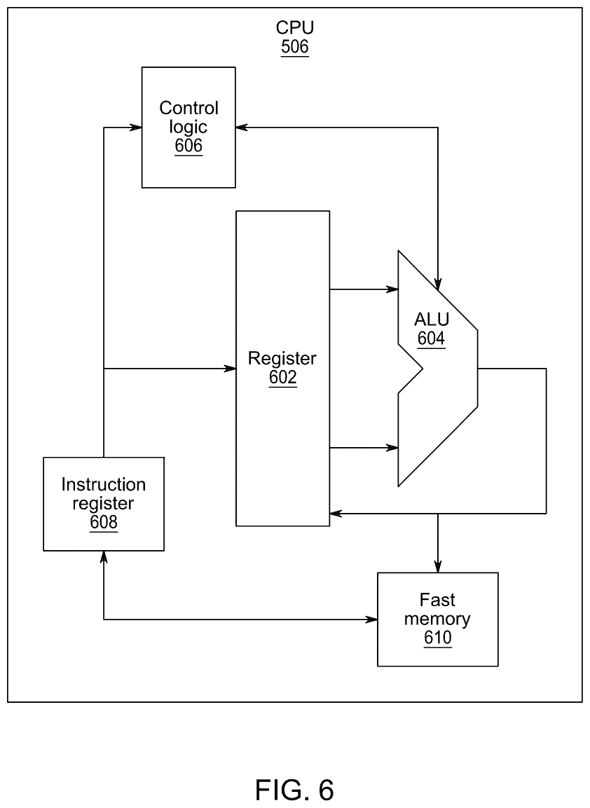

For example, FIG. 6 shows one implementation of the CPU 506. In one implementation, the instruction register 608 retrieves instructions from the fast memory 610. At least part of these instructions is fetched from the instruction register 608 by the control logic 606 and interpreted according to the instruction set architecture of the CPU 506. Part of the instructions can also be directed to the register 602. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 604 that loads values from the register 602 and performs logical and mathematical operations on the loaded values according to the instructions. The results from these operations can be feedback into the register 602 and/or stored in the fast memory 610. According to certain implementations, the instruction set architecture of the CPU 506 can use a reduced instruction set architecture, a complex instruction set architecture, a vector processor architecture, a very large instruction word architecture. Furthermore, the CPU 506 can be based on a Von Neuman model or a Harvard model. The CPU 506 can be a digital signal processor, the FPGA, the ASIC, the PLA, a PLD, or a CPLD. Further, the CPU 506 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 5, the data processing system 500 can include that the SB/ICH 504 is coupled through a system bus to an I/O Bus, a read only memory (ROM) 512, universal serial bus (USB) port 514, a flash binary input/output system (BIOS) 516, and a graphics controller 518. PCI/PCIe devices can also be coupled to SB/ICH 504 through a PCI bus 520.

The PCI devices may include, for example, Ethernet adapters, add-in cards, and PC cards for notebook computers. The Hard disk drive 522 and CD-ROM (optical drive) 524 can use, for example, an integrated drive electronics (IDE) or serial advanced technology attachment (SATA) interface. In one implementation the I/O bus can include a super I/O (SIO) device.

Further, the hard disk drive (HDD) 522 and optical drive 524 can also be coupled to the SB/ICH 504 through a system bus. In one implementation, a keyboard 526, a mouse 528, a parallel port 530, and a serial port 532 can be connected to the system bus through the I/O bus. Other peripherals and devices that can be connected to the SB/ICH 504 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

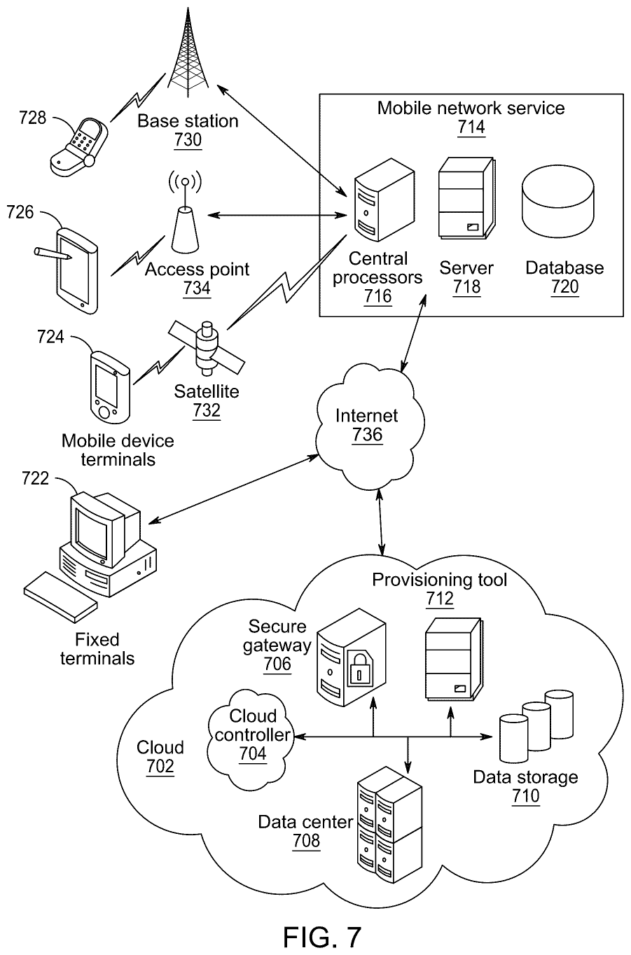

The functions and features described herein may also be executed by various distributed components of a system. For example, one or more processors may execute these system functions, wherein the processors are distributed across multiple components communicating in a network. The distributed components may include one or more client and server machines, such as cloud 702 including a cloud controller 704, a secure gateway 706, a data center 708, data storage 710 and a provisioning tool 712, and mobile network services 714 including central processors 716, a server 718 and a database 720, which may share processing, as shown by FIG. 7, in addition to various human interface and communication devices (e.g., display monitors 722, smart phones 724, tablets 726, personal digital assistants (PDAs) 728). The network may be a private network, such as a base station 730, satellite 732 or access point 734, or be a public network, may such as the Internet 736. Input to the system may be received via direct user input and received remotely either in real-time or as a batch process. Additionally, some implementations may be performed on modules or hardware that are not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer workstation system having memory and processing circuitry and equipped with a software tool for automatically detecting code smells in a source code in any of a plurality of object-oriented programming languages and performing language-specific code correction, comprising:
a user input device configured to select and retrieve a source code file with the source code from the memory;
the memory storing a Domain Specific Language (DSL) component for maintaining a representation of linguistic structures of a DSL using a formal grammar, wherein the DSL is a language-independent formal language to solve a class of problems in a domain of knowledge;
the processing circuitry configured with
a code smells detection component to apply smell detection rules to the source code in the source code file to detect potential code smells, wherein each smell detection rule is for detecting a code smell type, wherein the code smells detection component maintains an extensible set of smell specifications templates;
a code smells correction component that applies the DSL to specify specific corrective actions for each detected code smell and generates corrected source code based on the corrective actions; and
a reporting component that outputs a file with a correction report for the corrected source code to the memory.

2. The system of claim 1, wherein the code smells detection component maintains the smell specifications templates based on the DSL and divides a description of the code smells into structural, lexical, and measurable code smell characteristics, and
wherein the code smells detection component detects the code smells in accordance with whether the code smell type has structural, lexical, or measurable code smell characteristics.

3. The system of claim 1, wherein the code smells detection component maintains the smell specifications templates to include a vocabulary that distinguishes between intra-class smells, which comprise smells within a same class, and inter-class smells, representing smells that are propagating in other classes, and
wherein the code smells detection component automatically generates a set of classification rules based on the smell specifications templates that distinguish between the inter-class smells and the intra-class smells.

4. The system of claim 1, wherein the code smells detection component performs a rules generation algorithm to generate new code smell detection rules.

5. The system of claim 4, wherein the rules generation algorithm includes
a Cuckoo Search (CS) algorithm that receives as input code smell specifications, base examples, and a set of metrics and generates an optimal set of rules that initialize a rule engine.

6. The system of claim 5, wherein the rules generation algorithm includes
a genetic-based algorithm (GA) that modifies the generated rules to enhance their quality before generating a final set of rules.

7. The system of claim 4, wherein the rules generation algorithm
stores the generated rules in the memory and applies the generated rules to the source code to detect smelly instances, and
outputs the file with the report that lists a set of identified classes and methods whose properties and relationships conform to the generated rules from code smells specifications and base examples.

8. The system of claim 1, wherein each smell detection rule is 16 items long; a first 15 items contain metrics and their threshold values, and a final item defines the code smell type.

9. The system of claim 5, wherein the Cuckoo Search (CS) algorithm includes randomly generating initial solutions, selecting 3 to 5 metrics from an available 15, and assigning each metric a random value within a predefined range to narrow search space, evolving and mutating these solutions through a search process until either convergence is reached or a predetermined number of iterations is completed.

10. The system of claim 6, wherein the genetic-based algorithm (GA) includes applying a fitness function that evaluates the quality of the generated rules, as
$$F ( norm ) = \frac{{\sum }_{i = 0}^{c} \frac{{a}_{ic}}{c} + \frac{{a}_{is}}{s}}{2} ,$$
where c is a number of classes in the base example, s is a number of code smell types considered, and α_{ic} is the number of classes detected with a smell.

11. A non-transitory computer-readable storage medium including computer executable instructions, wherein the instructions, when executed by a computer, cause the computer to perform a method for automatically detecting code smells in a source code in any of a plurality of object-oriented programming languages and performing language-specific code correction, the method comprising:
selecting and retrieving a source code file having the source code;
maintaining, in memory, representations of linguistic structures of a Domain Specific Language (DSL) using a formal grammar, wherein the DSL is a language-independent formal language to solve a class of problems in a domain of knowledge;
applying, by the processing circuitry, smell detection rules to the source code in the source code files to detect potential code smells, wherein each smell detection rule is for detecting a code smell type, wherein the processing circuitry maintains an extensible set of smell specifications templates;
applying the DSL to specify specific corrective actions for each detected code smell and generating, by the processing circuitry, corrected source code based on the corrective actions; and
outputting a file with a correction report for the corrected source code to the memory.

12. The computer-readable storage medium of claim 11, further comprising:
maintaining, by the processing circuitry, the smell specifications templates based on the DSL and dividing a description of the code smells into structural, lexical, and measurable code smell characteristics; and
detecting, by the processing circuitry, the code smells in accordance with whether the code smell type has structural, lexical, or measurable code smell characteristics.

13. The computer-readable storage medium of claim 11, further comprising:
maintaining, by the processing circuitry, the smell specifications templates to include a vocabulary that distinguishes between intra-class smells, which comprise smells within a same class, and inter-class smells, representing smells that are propagating in other classes, and
automatically generating, by the processing circuitry, a set of classification rules based on the smell specifications templates that distinguish between the inter-class smells and the intra-class smells.

14. The computer-readable storage medium of claim 11, further comprising performing, by the processing circuitry, a rules generation algorithm to generate new code smell detection rules.

15. The computer-readable storage medium of claim 14, further comprising receiving, by a Cuckoo Search (CS) algorithm, as input code smell specifications, base examples, and a set of metrics and generating an optimal set of rules that initialize a rule engine.

16. The computer-readable storage medium of claim 15, further comprising mutating, by a genetic-based algorithm (GA), the generated rules to enhance their quality before generating a final set of rules.

17. The computer-readable storage medium of claim 14, further comprising:
storing the generated rules in the memory and applying the generated rules to the source code to detect smelly instances; and
outputting the file with the report that lists a set of identified classes and methods whose properties and relationships conform to the generated rules from code smells specifications and base examples.

18. The computer-readable storage medium of claim 11, wherein each smell detection rule is 16 items long; a first 15 items contain metrics and their threshold values, and a final item defines the code smell type.

19. The computer-readable storage medium of claim 15, further comprising:
performing the Cuckoo Search (CS) algorithm by randomly generating initial solutions;
selecting 3 to 5 metrics from an available 15;
assigning each metric a random value within a predefined range to narrow search space; and
evolving and mutating these solutions through a search process until either convergence is reached or a predetermined number of iterations is completed.

20. The computer-readable storage medium of claim 16, further comprising performing the genetic-based algorithm (GA) includes applying a fitness function that evaluates the quality of the generated rules, as
$$F ( norm ) = \frac{{\sum }_{i = 0}^{c} \frac{{a}_{ic}}{c} + \frac{{a}_{is}}{s}}{2} ,$$
where c is a number of classes in the base example, s is a number of code smell types considered, and α_{ic} is the number of classes detected with a smell.
